(19) United States
(12) Patent Application Publication
(10) Pub. No.: US 2025/0167905 A1
(43) Pub. Date: May 22, 2025

(54) TECHNIQUES FOR BEAM CHARACTERISTIC PREDICTION USING FEDERATED LEARNING PROCESSES

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Tao LUO, San Diego, CA (US)

(21) Appl. No.: 18/841,811

(22) PCT Filed: May 6, 2022
(86) PCT No.: PCT/CN2022/091092

§ 371 Date: Aug. 27, 2024

(51) Int. Cl. H04B 17/391; H04B 17/309; H04L 41/16

(52) U.S. Cl. CPC H04B 17/3913; H04B 17/309; H04L 41/16

(57) ABSTRACT

Methods, systems, and devices for wireless communications are described. A first network node, such as a user equipment (UE), may receive a first model configured to predict at least one of time-domain characteristics or spatial-domain characteristics associated with a set of channel measurement resources (CMRs). The first network node may generate first measurement information corresponding to a first quantity of CMRs of the set of CMRs and may input the first measurement information into the first model. The first network node may obtain, as an output of the first model, first predicted information corresponding to a second quantity of CMRs of the set of CMRs, receive signals using the second quantity of CMRs, and generate second measurement information corresponding to the second quantity of CMRs. The first network node may train the first model with the second measurement information and transmit the trained first model to a second network node.

### CROSS REFERENCE

The present Application is a 371 national phase filing of International PCT Application No. PCT/CN2022/091092 by LI et al., entitled “TECHNIQUES FOR BEAM CHARACTERISTIC PREDICTION USING FEDERATED LEARNING PROCESSES,” filed May 6, 2022, which is assigned to the assignee hereof, and which is expressly incorporated by reference in its entirety herein.

### INTRODUCTION

The following relates to wireless communications, including techniques for beam characteristic prediction using federated learning processes.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for beam characteristic prediction using federated learning processes. For example, the described techniques provide for implementing federated learning models between the network and other network nodes (e.g., user equipments (UEs) to facilitate prediction of time and spatial characteristics of future beams, or future communications. Specifically, aspects of the present disclosure support techniques which enable a first network node (e.g., base station, network entity) to configure multiple network nodes (e.g., UEs) with federated learning models that are associated with respective sets of channel measurement resources (CMRs). In such cases, the first network node may aggregate trained federated learning models from the respective network nodes, and distribute an aggregated (e.g., composite) federated learning model across the respective network nodes (e.g., UEs) such that the first network node and the respective network nodes are configured to use the same model to predict/estimate beam characteristics.

A method for wireless communication at a first network node is described. The method may include receiving a first model configured to predict at least one of time-domain characteristics or spatial-domain characteristics associated with a set of CMRs, generating first measurement information corresponding to a first quantity of CMRs of the set of CMRs, where the first quantity of CMRs correspond to a first set of signals, inputting the first measurement information into the first model, obtaining, as an output of the first model, first predicted information corresponding to a second quantity of CMRs of the set of CMRs, where the first predicted information includes at least one of: one or more predicted time-domain parameters or one or more predicted spatial-domain parameters, and receiving a second set of signals, where the second quantity of CMRs correspond to the second set of signals.

A first network node for wireless communication is described. The first network node may include a memory and at least one processor coupled to the memory. The at least one processor may be configured to receive a first model configured to predict at least one of time-domain characteristics or spatial-domain characteristics associated with a set of CMRs, generate first measurement information corresponding to a first quantity of CMRs of the set of CMRs, where the first quantity of CMRs correspond to a first set of signals, input the first measurement information into the first model, obtain, as an output of the first model, first predicted information corresponding to a second quantity of CMRs of the set of CMRs, where the first predicted information includes at least one of: one or more predicted time-domain parameters or one or more predicted spatial-domain parameters, and receive a second set of signals, where the second quantity of CMRs correspond to the second set of signals.

An apparatus for wireless communication at a first network node is described. The apparatus may include a processor, memory coupled with the processor, and instructions stored in the memory. The instructions may be executable by the processor to cause the apparatus to receive a first model configured to predict at least one of time-domain characteristics or spatial-domain characteristics associated with a set of CMRs, generate first measurement information corresponding to a first quantity of CMRs of the set of CMRs, where the first quantity of CMRs correspond to a first set of signals, input the first measurement information into the first model, obtain, as an output of the first model, first predicted information corresponding to a second quantity of CMRs of the set of CMRs, where the first predicted information includes at least one of: one or more predicted time-domain parameters or one or more predicted spatial-domain parameters, and receive a second set of signals, where the second quantity of CMRs correspond to the second set of signals.

Another apparatus for wireless communication at a first network node is described. The apparatus may include means for receiving a first model configured to predict at least one of time-domain characteristics or spatial-domain characteristics associated with a set of CMRs, means for generating first measurement information corresponding to a first quantity of CMRs of the set of CMRs, where the first quantity of CMRs correspond to a first set of signals, means for inputting the first measurement information into the first model, means for obtaining, as an output of the first model, first predicted information corresponding to a second quantity of CMRs of the set of CMRs, where the first predicted information includes at least one of: one or more predicted time-domain parameters or one or more predicted spatial-domain parameters, and means for receiving a second set of signals, where the second quantity of CMRs correspond to the second set of signals.

A non-transitory computer-readable medium storing code for wireless communication at a first network node is described. The code may include instructions executable by a processor to receive a first model configured to predict at least one of time-domain characteristics or spatial-domain characteristics associated with a set of CMRs, generate first measurement information corresponding to a first quantity of CMRs of the set of CMRs, where the first quantity of CMRs correspond to a first set of signals, input the first measurement information into the first model, obtain, as an output of the first model, first predicted information corresponding to a second quantity of CMRs of the set of CMRs, where the first predicted information includes at least one of: one or more predicted time-domain parameters or one or more predicted spatial-domain parameters, and receive a second set of signals, where the second quantity of CMRs correspond to the second set of signals.

Some examples of the method, apparatuses, and non-transitory computer-readable medium described herein may further include operations, features, means, or instructions for generating second measurement information corresponding to the second quantity of CMRs, training the first model with the second measurement information, where training the first model with the second measurement information includes inputting the second measurement information into the first model, and transmitting the trained first model to a second network node.

Some examples of the method, apparatuses, and non-transitory computer-readable medium described herein may further include operations, features, means, or instructions for receiving, from the second network node, a second model based on the trained first model and a third model associated with the set of CMRs, where the second model may be configured to predict least one of time-domain characteristics or spatial-domain characteristics of the set of CMRs and obtaining, as an output of the second model, second predicted information corresponding to the set of CMRs, where the second predicted information includes at least one of: one or more time-domain parameters or one or more spatial-domain parameters.

Some examples of the method, apparatuses, and non-transitory computer-readable medium described herein may further include operations, features, means, or instructions for training the first model with a set of identifiers associated with the second quantity of CMRs, where the set of identifiers corresponds to the second measurement information, and where training the first model with the set of identifiers includes inputting the set of identifiers into the first model.

Some examples of the method, apparatuses, and non-transitory computer-readable medium described herein may further include operations, features, means, or instructions for receiving, from a second network node, control information indicating at least one of: the first quantity of CMRs or the second quantity of CMRs.

In some examples of the method, apparatuses, and non-transitory computer-readable medium described herein, the first quantity of CMRs may be based on the periodicity, or the second quantity of CMRs may be based on the periodicity.

In some examples of the method, apparatuses, and non-transitory computer-readable medium described herein, the first quantity of CMRs may be associated with a first set of time instances, the second quantity of CMRs may be associated with a second set of time instances different from the first set of time instances, and the one or more predicted time-domain parameters include predicted measurements associated with the second quantity of CMRs associated with the second set of time instances.

In some examples of the method, apparatuses, and non-transitory computer-readable medium described herein, the first quantity of CMRs may be associated with a first set of spatial filters at a second network node, the second quantity of CMRs may be associated with a second set of spatial filters at the second network node, and the one or more predicted spatial-domain parameters include predicted measurements associated with the second quantity of CMRs transmitted via the second set of spatial filters at the second network node.

Some examples of the method, apparatuses, and non-transitory computer-readable medium described herein may further include operations, features, means, or instructions for receiving a first set of beams, where the first set of beams includes the first set of signals corresponding to the first quantity of CMRs and inputting a first set of beam identifiers corresponding to the first set of beams into the first model, where the first predicted information may be based on the first set of beam identifiers.

Some examples of the method, apparatuses, and non-transitory computer-readable medium described herein may further include operations, features, means, or instructions for obtaining, as an additional output of the first model, second predicted information including a second set of beam identifiers corresponding to a second set of beams, the second set of beam identifiers associated with the second quantity of CMRs.

In some examples of the method, apparatuses, and non-transitory computer-readable medium described herein, the first model may be associated with one or more serving cells, one or more bandwidth parts, one or more CMR sets, a channel state information reporting configuration, or any combination thereof.

Some examples of the method, apparatuses, and non-transitory computer-readable medium described herein may further include operations, features, means, or instructions for receiving, from a second network node, control information indicating the one or more serving cells, the one or more bandwidth parts, the one or more CMR sets, the channel state information reporting configuration, or any combination thereof.

In some examples of the method, apparatuses, and non-transitory computer-readable medium described herein, the first model includes a federated learning model, a distributed learning model, a machine learning model, or any combination thereof.

Some examples of the method, apparatuses, and non-transitory computer-readable medium described herein may further include operations, features, means, or instructions for receiving the first model includes receiving the first model from a second network node, the first network node includes a UE, and the second network node includes a base station, a network entity, a server, or any combination thereof.

In some examples of the method, apparatuses, and non-transitory computer-readable medium described herein, and the method, apparatuses, and non-transitory computer-readable medium may include further operations, features, means, or instructions for channel state information reference signal resources or synchronization signal block resources.

In some examples of the method, apparatuses, and non-transitory computer-readable medium described herein, a reference signal received power, a signal-to-noise ratio, a signal-to-interference-plus-noise ratio, a channel quality indicator, a rank indicator, a pre-coding matrix indicator, or any combination thereof.

In some examples of the method, apparatuses, and non-transitory computer-readable medium described herein, receiving the first model may include operations, features, means, or instructions for receiving a download including the first model and receiving the first model via control signaling from a second network node, or both.

A method for wireless communication at a first network node is described. The method may include transmitting signals within a set of CMRs, receiving, from a second network node, a first trained model associated with at least a first portion of the set of CMRs, the first trained model configured to predict at least one of time-domain characteristics or spatial-domain characteristics associated with the set of CMRs, receiving, from a third network node, a second trained model associated with at least a second portion of the set of CMRs, the second trained model configured to predict at least one of time-domain characteristics or spatial-domain characteristics of the set of CMRs, generating a third model based on the first trained model and the second trained model, the third model configured to predict at least one of time-domain characteristics or spatial-domain characteristics associated with the set of CMRs, and transmitting, to at least one of the second network node or the third network node, an indication of the third model.

A first network node for wireless communication is described. The first network node may include a memory and at least one processor coupled to the memory. The at least one processor may be configured to transmit signals within a set of CMRs, receive, from a second network node, a first trained model associated with at least a first portion of the set of CMRs, the first trained model configured to predict at least one of time-domain characteristics or spatial-domain characteristics associated with the set of CMRs, receive, from a third network node, a second trained model associated with at least a second portion of the set of CMRs, the second trained model configured to predict at least one of time-domain characteristics or spatial-domain characteristics of the set of CMRs, generate a third model based on the first trained model and the second trained model, the third model configured to predict at least one of time-domain characteristics or spatial-domain characteristics associated with the set of CMRs, and transmit, to at least one of the second network node or the third network node, an indication of the third model.

An apparatus for wireless communication at a first network node is described. The apparatus may include a processor, memory coupled with the processor, and instructions stored in the memory. The instructions may be executable by the processor to cause the apparatus to transmit signals within a set of CMRs, receive, from a second network node, a first trained model associated with at least a first portion of the set of CMRs, the first trained model configured to predict at least one of time-domain characteristics or spatial-domain characteristics associated with the set of CMRs, receive, from a third network node, a second trained model associated with at least a second portion of the set of CMRs, the second trained model configured to predict at least one of time-domain characteristics or spatial-domain characteristics of the set of CMRs, generate a third model based on the first trained model and the second trained model, the third model configured to predict at least one of time-domain characteristics or spatial-domain characteristics associated with the set of CMRs, and transmit, to at least one of the second network node or the third network node, an indication of the third model.

Another apparatus for wireless communication at a first network node is described. The apparatus may include means for transmitting signals within a set of CMRs, means for receiving, from a second network node, a first trained model associated with at least a first portion of the set of CMRs, the first trained model configured to predict at least one of time-domain characteristics or spatial-domain characteristics associated with the set of CMRs, means for receiving, from a third network node, a second trained model associated with at least a second portion of the set of CMRs, the second trained model configured to predict at least one of time-domain characteristics or spatial-domain characteristics of the set of CMRs, means for generating a third model based on the first trained model and the second trained model, the third model configured to predict at least one of time-domain characteristics or spatial-domain characteristics associated with the set of CMRs, and means for transmitting, to at least one of the second network node or the third network node, an indication of the third model.

A non-transitory computer-readable medium storing code for wireless communication at a first network node is described. The code may include instructions executable by a processor to transmit signals within a set of CMRs, receive, from a second network node, a first trained model associated with at least a first portion of the set of CMRs, the first trained model configured to predict at least one of time-domain characteristics or spatial-domain characteristics associated with the set of CMRs, receive, from a third network node, a second trained model associated with at least a second portion of the set of CMRs, the second trained model configured to predict at least one of time-domain characteristics or spatial-domain characteristics of the set of CMRs, generate a third model based on the first trained model and the second trained model, the third model configured to predict at least one of time-domain characteristics or spatial-domain characteristics associated with the set of CMRs, and transmit, to at least one of the second network node or the third network node, an indication of the third model.

Some examples of the method, apparatuses, and non-transitory computer-readable medium described herein may further include operations, features, means, or instructions for transmitting, to the second network node, control information indicating at least one of: a first quantity of CMRs of the set of CMRs or a second quantity of CMRs of the set of CMRs, where the first trained model may be trained based on a subset of the signals transmitted within the first quantity of CMRs.

In some examples of the method, apparatuses, and non-transitory computer-readable medium described herein, a periodicity may be associated with the set of CMRs and at least one of the first quantity of CMRs or the second quantity of CMRs may be based on the periodicity.

In some examples of the method, apparatuses, and non-transitory computer-readable medium described herein, the third model may be associated with one or more serving cells, one or more bandwidth parts, one or more CMR sets, a channel state information reporting configuration, or any combination thereof.

Some examples of the method, apparatuses, and non-transitory computer-readable medium described herein may further include operations, features, means, or instructions for transmitting, to at least one of the second network node or the third network node, control information indicating the one or more serving cells, the one or more bandwidth parts, the one or more CMR sets, the channel state information reporting configuration, or any combination thereof.

In some examples of the method, apparatuses, and non-transitory computer-readable medium described herein, the third model includes a federated learning model, a distributed learning model, a machine learning model, or any combination thereof.

In some examples of the method, apparatuses, and non-transitory computer-readable medium described herein, at least one of the second network node or the third network node, includes a respective UE and the first network node includes a base station, a network entity, a server, or any combination thereof.

In some examples of the method, apparatuses, and non-transitory computer-readable medium described herein, the set of CMRs includes at least one of channel state information reference signal resources or synchronization signal block resources.

In some examples of the method, apparatuses, and non-transitory computer-readable medium described herein, the first portion of the set of CMRs may be the same as the second portion of the set of CMRs.

### BRIEF DESCRIPTION OF THE DRAWINGS

FIGS. 1 and 2 show examples of wireless communications systems that support techniques for beam characteristic prediction using federated learning processes in accordance with one or more aspects of the present disclosure.

FIGS. 3 and 4 show examples of model training procedures that support techniques for beam characteristic prediction using federated learning processes in accordance with one or more aspects of the present disclosure.

FIG. 5 shows an example of a process flow that supports techniques for beam characteristic prediction using federated learning processes in accordance with one or more aspects of the present disclosure.

FIGS. 6 and 7 show block diagrams of devices that support techniques for beam characteristic prediction using federated learning processes in accordance with one or more aspects of the present disclosure.

FIG. 8 shows a block diagram of a communications manager that supports techniques for beam characteristic prediction using federated learning processes in accordance with one or more aspects of the present disclosure.

FIG. 9 shows a diagram of a system including a device that supports techniques for beam characteristic prediction using federated learning processes in accordance with one or more aspects of the present disclosure.

FIGS. 10 and 11 show block diagrams of devices that support techniques for beam characteristic prediction using federated learning processes in accordance with one or more aspects of the present disclosure.

FIG. 12 shows a block diagram of a communications manager that supports techniques for beam characteristic prediction using federated learning processes in accordance with one or more aspects of the present disclosure.

FIG. 13 shows a diagram of a system including a device that supports techniques for beam characteristic prediction using federated learning processes in accordance with one or more aspects of the present disclosure.

FIGS. 14 and 15 show flowcharts illustrating methods that support techniques for beam characteristic prediction using federated learning processes in accordance with one or more aspects of the present disclosure.

### DETAILED DESCRIPTION

In some wireless communications systems, network nodes, such as user equipments (UEs) and base stations, may perform beam management procedures in order to determine beam characteristics. For example, during a beam management procedure, a first network node (e.g., UE) may refine a transmit (Tx) beam, a receive (Rx) beam, and spatial filters defining the beams and that will exhibit sufficient performance for wireless communications between the first network node and a second network node (e.g., a base station). For instance, the first network node (UE) may perform measurements on reference signals received from the second network node (base station) using different Rx beams, and may transmit a measurement report that enables the second network node to determine beam characteristics for future communications. In some wireless communications systems, network nodes (e.g., UEs, base stations, network entities) may be configured to utilize machine learning models to determine and predict beam characteristics. However, the use of different models across the different network nodes (and/or different inputs/outputs to and from the models) may result in discrepancies between beam characteristics determined/predicted by the respective network nodes.

Accordingly, aspects of the present disclosure are directed to techniques for implementing federated learning models between network nodes (e.g., between the network and UEs) to facilitate prediction of time and spatial characteristics of future beams/communications. Specifically, the techniques described enable the network to configure multiple UEs with federated learning models, aggregate trained federated learning models from the respective UEs, and distribute an aggregated (e.g., composite) federated learning model across the UEs such that the network and UEs are configured to use the same model to predict/estimate beam characteristics.

For example, a first network node (e.g., UE) may receive a model (e.g., federated learning model) associated with a set of channel measurement resources (CMRs) from a second network node (e.g., base station, network entity). The first network node may perform measurements on a first subset of the CMRs, and input the measurements into the model. The model is configured to output time-domain parameters (e.g., predicted channel measurements) and/or spatial-domain parameters (e.g., predicted Tx beams with sufficient quality) for a second subset of the CMRs. Additional measurements performed on the second subset of CMRs may be inputted into the model as “labels” used to further train the model. Subsequently, the first network node may transmit the trained model to the second network node, where the second network node compiles multiple trained models across multiple network nodes (e.g., trained models from multiple UEs), generates an aggregate/composite model, and re-distributes the aggregate/composite model to the respective network nodes for predicting future beam characteristics.

Aspects of the disclosure are initially described in the context of wireless communications systems. Additional aspects of the disclosure are described in the context of example model training procedures and an example process flow. Aspects of the disclosure are further illustrated by and described with reference to apparatus diagrams, system diagrams, and flowcharts that relate to techniques for beam characteristic prediction using federated learning processes.

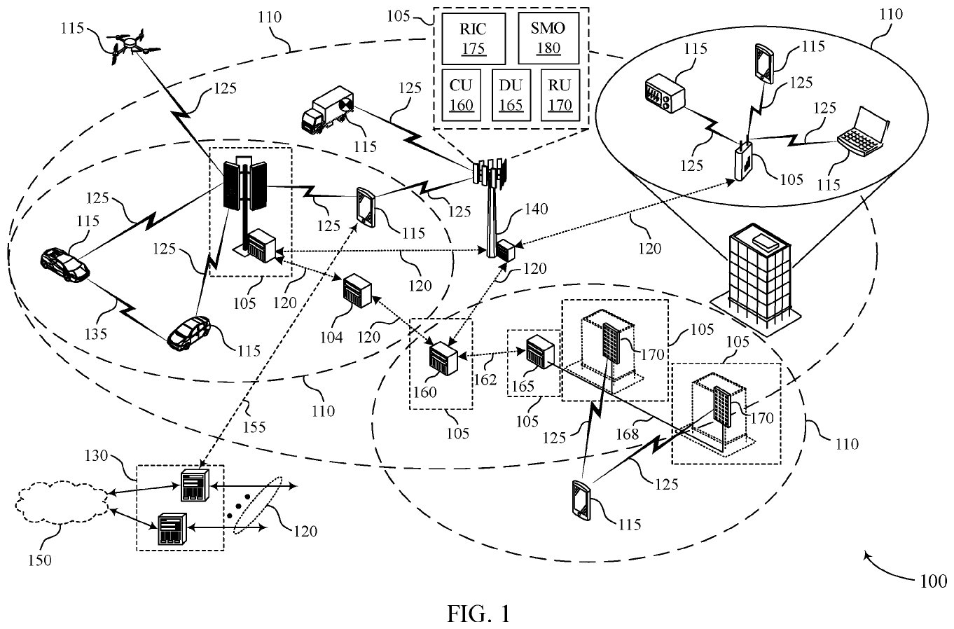

FIG. 1 shows an example of a wireless communications system 100 that supports techniques for beam characteristic prediction using federated learning processes in accordance with one or more aspects of the present disclosure. The wireless communications system 100 may include one or more network entities 105, one or more UEs 115, and a core network 130. In some aspects, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some aspects, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote unit (RU), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some aspects, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some aspects, network entities 105 may communicate with one another over a backhaul communication link 120 (e.g., in accordance with an X2, Xn, or other interface protocol) either directly (e.g., directly between network entities 105) or indirectly (e.g., via a core network 130). In some aspects, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some aspects, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some aspects, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some aspects, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some aspects, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some aspects, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some aspects, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for beam characteristic prediction using federated learning processes as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some aspects, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and Ne may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some aspects, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some aspects, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some aspects, a network entity 105 (e.g., a base station 140, an RU 170) may be movable and therefore provide communication coverage for a moving coverage area 110. In some aspects, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, In some aspects, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some aspects, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some aspects, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some aspects, a UE 115 may be able to communicate directly with other UEs 115 over a device-to-device (D2D) communication link 135 (e.g., in accordance with a peer-to-peer (P2P), D2D, or sidelink protocol). In some aspects, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some aspects, one or more UEs 115 in such a group may be outside the coverage area 110 of a network entity 105 or may be otherwise unable to or not configured to receive transmissions from a network entity 105. In some aspects, groups of the UEs 115 communicating via D2D communications may support a one-to-many (1:M) system in which each UE 115 transmits to each of the other UEs 115 in the group. In some aspects, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some aspects, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some aspects, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some aspects, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some aspects, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some aspects, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some aspects, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some aspects, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some aspects, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some aspects, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some aspects, a device may support same-slot HARQ feedback, where the device may provide HARQ feedback in a specific slot for data received in a previous symbol in the slot. In some other examples, the device may provide HARQ feedback in a subsequent slot, or according to some other time interval.

In some aspects, the network nodes (e.g., UEs 115, network entities 105, base stations) of the wireless communications system 100 may support signaling and techniques for implementing federated learning models between network nodes (e.g., between the network and UEs 115) to facilitate prediction of time and spatial characteristics of future beams/communications. Specifically, the techniques described enable the network to configure multiple UEs 115 with federated learning models, aggregate trained federated learning models from the respective UEs 115, and distribute an aggregated (e.g., composite) federated learning model across the UEs 115 such that the network and UEs 115 are configured to use the same model to predict/estimate beam characteristics.

For example, a first network node (e.g., network entity 105) of the wireless communications system 100 may transmit a model (e.g., federated learning model) associated with a set of CMRs to a second network node (e.g., UE 115). The second network node may perform measurements on a first subset of the CMRs, and input the measurements into the model. In some aspects, the model may be configured to output time-domain parameters (e.g., predicted channel measurements) and/or spatial-domain parameters (e.g., predicted Tx beams with sufficient quality) for a second subset of the CMRs. Additional measurements performed on the second subset of CMRs may be inputted into the model as “labels” used to further train the model. Subsequently, the second network node (UE 115) may transmit the trained model to the first network node (network entity 105), where the first network node compiles multiple trained models across multiple network nodes (e.g., trained models from multiple UEs 115), generates an aggregate/composite model, and re-distributes the aggregate/composite model to the respective network nodes (UEs 115) for predicting future beam characteristics.

Techniques described herein may facilitate more efficient and accurate prediction of beam characteristics using models, such as federated learning models, distributed models, machine learning models, and the like. By enabling network nodes to more accurately predict beam characteristics for future communications, techniques described herein may enable the network to more efficiently schedule wireless communications, and may enable the respective network nodes to perform communications using parameters (e.g., Tx beams, Rx beams) that will exhibit sufficient performance. As such, aspects of the present disclosure may enable more efficient and reliable wireless communications within the wireless communications system 100.

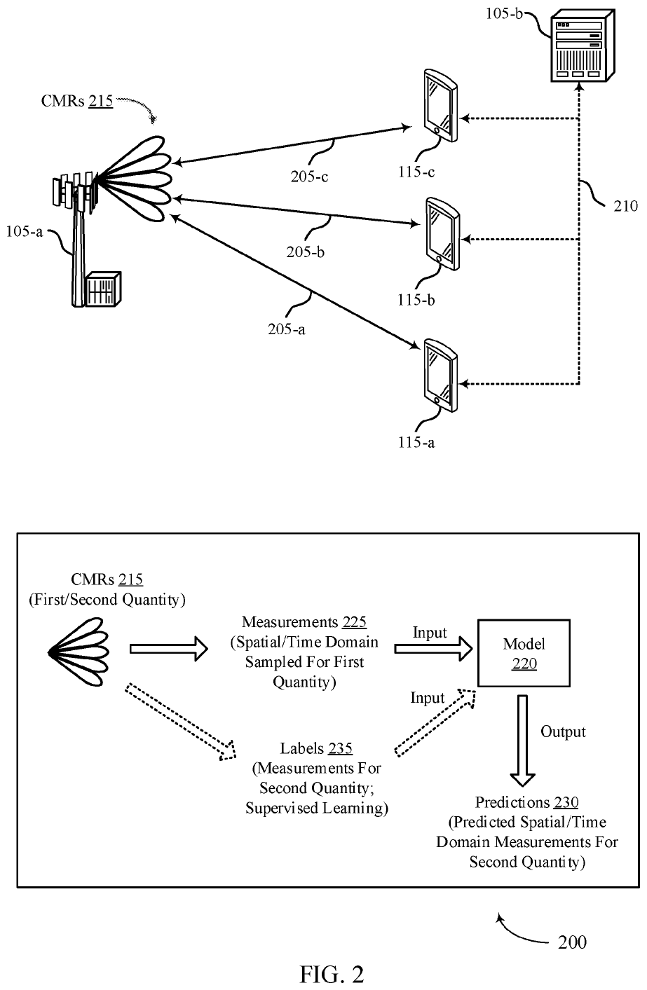

FIG. 2 shows an example of a wireless communications system 200 that supports techniques for beam characteristic prediction using federated learning processes in accordance with one or more aspects of the present disclosure. In some examples, aspects of the wireless communications system 200 may implement, or be implemented by, aspects of the wireless communications system 100. In particular, the wireless communications system 200 may support signaling and techniques which enable network nodes (e.g., UEs 115, network entities 105) to predict beam characteristics for future communications using models, such as FL models, distributed learning models, machine learning models, and the like.

The wireless communications system 200 may include multiple network nodes, which may be examples of network entities 105 and UEs 115 as described with reference to FIG. 1. For example, the wireless communications system 200 may include a first network node 105-a, which may be an example of a base station or network entity 105, and one or more additional network nodes 115-a, 115-b, and 115-d, which may be examples of UEs 115. The network nodes 105-a, 115-b, 115-b may communicate with the first network node 105-a using communication links 205-a, 205-b, and 205-c, respectively, which may be examples of NR or LTE links between the respective network nodes 115 and the first network node 105-a. In some cases, the communication links 205 may include examples of an access links (e.g., Uu links) which may include bi-directional links that enable both uplink and downlink communication. For example, the second network node 115-a (e.g., UE 115-a) may transmit uplink signals, such as uplink control signals or uplink data signals, to one or more components of the first network node 105-a using the communication link 205-a, and one or more components of the first network node 105-a may transmit downlink signals, such as downlink control signals or downlink data signals, to the second network node 115-a using the communication link 205-a.

In some aspects, the wireless communications system 200 may include an additional network node 105-b. The additional network node 105-b may include a server, a network entity 105, and the like. In some aspects, the additional network node 105-b may include, or be associated with, the first network node 105-a. In other implementations, the additional network node 105-b may be separate from the network node 105-a, but may be communicatively coupled to (e.g., coupled with) the respective devices of the wireless communications system 200 via a communication link 210. For example, the network nodes 115-a, 115-b, and 115-c may be communicatively coupled to (e.g., coupled with) the additional network node 105-b via a communication link 210.

In some aspects, the network nodes of the wireless communications system 200 may perform beam management procedures in order to determine beam characteristics that will be used for wireless communications between the respective network nodes. For example, during an initial access phase of a beam management procedure, the network node 115-a (e.g., UE) may sweep across beams or reference signals (e.g., synchronization signal block (SSB) sweeping) as the network node 115-a receives signals from the first network node 105-a to determine which Rx beams will be used at the network node 115-a to communicate with the first network node 105-a (e.g., SSB and RACH association). In other words, the network node 115-a may perform an SSB beam sweep and/or a CSI-RS beam sweep as part of a beam management procedure. Once in a connected mode, the respective network nodes may perform hierarchical beam refinement procedures (e.g., P1, P2, P3 procedures, or U1, U2, U3 procedures) in which the respective network nodes sweep across narrower beams to refine which beams will be used for wireless communications. The network node 115-a may transmit Layer 1 (L1) reports for beam refinement.

During beam management procedures, the respective network nodes may be configured to identify and/or predict beam characteristics in time and/or spatial-domain for overhead and latency reduction, as well as beam selection accuracy improvement. In other words, the network nodes may be configured to predict channel conditions and corresponding beam characteristics that will be used at different points in time in the future, and/or predict channel conditions that will be experienced using different Tx/Rx beam combinations. Beam management procedures may also enable positioning accuracy enhancements for different scenarios, such as for heavy non-line-of-sight (NLOS) conditions.

Beam management procedures may be used to refine transmit (Tx) beams, receive (Rx) beams, and spatial filters defining the beams and that will exhibit sufficient performance for wireless communications between the first network node 105-a (network entity 105) and the second network node 115-a (UE 115). For instance, the second network node 115-b may perform measurements on reference signals received from the first network node 105-a (network entity 105) using different Rx beams, and may transmit a measurement report (e.g., CSI feedback) that enables the first network node 105-a to determine beam characteristics for future communications.

In some wireless communications systems, network nodes (e.g., UEs 115, base stations, network entities 105) may be configured to utilize machine learning models to determine and predict beam characteristics. However, the use of different models across the different network nodes (and/or different inputs/outputs to and from the models) may result in discrepancies between beam characteristics determined/predicted by the respective network nodes.

Accordingly, some aspects of the present disclosure are directed to the use of FL models (otherwise known as distributed learning models) associated with sets of CMRs to predict beam characteristics associated with the set of CMRs. In general, the wireless communications system 200 may implement FL models in which multiple models are trained at different network nodes (e.g., network nodes 115-a, 115-b, 115-c), aggregated into a composite model, and re-distributed to the respective network nodes. In other words, the wireless communications system 200 may enable FL models and other artificial intelligence (AI) models to be trained to predict time and spatial beam characteristics via computations at edge devices and servers.

For example, in the context of the wireless communications system 200, local training for a federated learning model may be triggered by an edge server, such as the additional network node 105-b. In this regard, the additional network node 105-b may transmit models (e.g., untrained models) to each of the network nodes 115-a, 115-b, 115-b for training. Stated differently, the network nodes 115-a, 115-b, 115-c may each download or retrieve a model from the additional network node 105-b. The network nodes 115 may train the received local models, for example, by performing measurements on signals received from the first network node 105-a, and inputting the measurements into the respective local models. In particular, the network nodes 115 may each train the respective local model to predict time and spatial characteristics of CMRs based on measurements input into the local models. As such, each local model will be trained differently based on the channel conditions (and therefore measurements) at each of the respective network nodes 115.

Continuing with the same example, the local models trained at the network nodes 115 may be aggregated (e.g., transmitted, uploaded) to an edge server or network node. For example, the network nodes 115-a, 115-b, 115-c may each transmit the trained local models to the first network node 105-a, the additional network node 105-b, or both. Parameters of the trained local models may be either parameters in a recurrent neural network (RNN), or gradients to derive the RNN. Subsequently, the first network node 105-a, the additional network node 105-b, or both, may aggregate and combine the received local models to generate or update an “aggregate” or “composite” model (e.g., global model). In some cases, aggregation of local models received from the network nodes 115 may include simple parameter/gradient averaging (e.g., FedAvg procedure). The updated aggregate/composite model (e.g., global model) may then be transmitted or broadcasted back to the edge devices (e.g., network nodes 115-a, 115-b, 115-c) so that the respective network nodes 115 may utilize the aggregate/composite model to predict time/spatial-domain characteristics of future CMRs and future communications.

Federated learning may provide several advantages over other types of models or learning procedures. In particular, federated learning may enable fast access to real-time data generated at edge devices (e.g., network nodes 115-a, 115-b, 115-c) for fast training of AI-models. Moreover, federated learning procedures described herein may reduce or eliminate the consumption of large quantities of wireless radio resources used for raw data transfer, and may enable improved privacy as raw data associated with the federated models (e.g., data used to train the respective federated models) does not necessarily need to be exchanged between the devices.

In the context of federated learning, different devices (e.g., network nodes 115-a, 115-b, 115-c) may be expected to train a common model with identical input/output/label definitions (which may be signaled from the network or first network node 105-a), and feed the trained models back to the network/first network node 105-a. Techniques described herein may utilize federated learning-based training (e.g., machine learning-based training) for beam prediction over spatial/time-domain by associating the respective models distributed across the network nodes 115-a, 115-b, 115-c with a defined beam measurement process operated by the respective network nodes 115 in order to determine proper inputs, outputs, and labels used for the models.

In other words, the local models distributed to (and trained by) each of the respective network nodes 115-a, 115-b, 115-c may be associated with (e.g., correspond to) a common set of CMRs such that the respective network nodes 115-a, 115-b, 115-c utilize similar or identical inputs, outputs, and labels to train the respective local models which will be aggregated to generate an aggregate/composite model for predicting time/spatial characteristics for the set of CMRs. As such, techniques described herein are directed to signaling and other configurations which enable the respective network nodes of the wireless communications system 200 (e.g., first network node 105-a, network nodes 115-a, 115-b, 115-c, additional network node 105-b) to be “on the same page” with respect to inputs, outputs, and labels used to train local models when federated learning techniques are used to train a common machine learning-model for beam prediction.

For example, in the context of a periodic CSI (P-CSI) report with report quantity ssb-Index-RSRP associated with sixteen SSB resources, the second network node 115-a may be configured to perform L1 reference signal received power (L1-RSRP) for the SSB resources, and use the periodically measured L1-RSRPs associated with a quantity of the sixteen SSB resources as inputs into a model (where the quantity of SSBs used as inputs may be spatial/time-domain down sampled). In this example, the model may be used to predict spatial and time characteristics of the set of SSBs as outputs (e.g., output predicted ssb-Index-RSRP). The non-down-sampled L1-RSRP measurements associated with the predicted measurements can be used as labels which are input back into the model to facilitate supervised trainings. In addition to the down-sampled and/or non-down-sampled downlink measurements (e.g., downlink beam qualities) used as inputs and outputs from the model, the second network node 105-b may also input Rx beams used to receive the respective SSBs at model inputs. For instance, in the case of UE 115 rotation or MPE events, the Rx beam may be altered gradually, thereby resulting in a corresponding Tx beam at the network entity 105 being altered gradually. As such, by inputting Rx beams into the model, the second network node 115-a may train the model to predict Rx beams which will exhibit superior performance in receiving future SSBs.

Aspects of the wireless communications system 200 may support signaling enhancements to support federated learning-based beam prediction and machine model training at the respective network nodes 115-a, 115-b, 115-c. In particular, the wireless communications system 200 may support network configurations which enable models (e.g., federated models) to be associated with one or more beam measurement procedures (e.g., CMRs), such that the network nodes 115-a, 115-b, 115-c are able to properly identify the inputs, outputs, and labels associated with federated learning process and corresponding models used for beam prediction throughout the wireless communications system 200. Moreover, aspects of the present disclosure may also enable the respective network nodes 115-a, 115-b, 115-b (e.g., UEs 115) to implicitly identify Rx beam info at the respective network nodes 115 as inputs which are used to further train the federated learning machine learning models.

Specifically, the wireless communications system 200 may support techniques for implementing federated learning models between network nodes (e.g., between the network and UEs 115) to facilitate prediction of time and spatial characteristics of future beams/communications. Techniques described enable the first network node 105-a and/or the additional network node 105-b to configure the respective network nodes 115-a, 115-b, 115-c with federated learning models, aggregate trained federated learning models from the respective network nodes 115, and distribute an aggregated (e.g., composite) federated learning model across the respective network nodes 115 such that the first network node 105-a and the respective network nodes 115-a, 115-b, 115-c are configured to use the same model to predict/estimate beam characteristics.

For example, referring to the wireless communications system 200 illustrated in FIG. 2, each network node 115-a, 115-b, 115-c may be configured by the network (e.g., by the first network node 105-a, the additional network node 105-b, or both) to locally train an model 220 (e.g., machine learning model, federated learning model, distributed learning model) for spatial/time-domain beam prediction. For example, in some cases, each network node 115 may download, retrieve, or otherwise receive a local model 220 that is to be trained by the respective network node 115.

In some aspects, the models 220 received by each network node 115 may be associated with a set of CMRs 215, where the models 220 are to be trained based on the CMRs 215, and used to predict beam characteristics associated with the CMRs 215. For example, the CMRs 215 illustrated in FIG. 2 may include CSI-RS resources, SSB resources, or both, which are associated with the model 220 received/downloaded at each respective network node 115. In this regard, the training procedure for the model 220 at each network node 115 may be associated with at least one set of CMRs 215 (e.g., CSI-RS resources, SSB resources), such that the inputs, outputs, and/or labels (e.g., data labeling) associated with the training process for the federated learning model 220 are associated with the set of CMRs 215.

The association between the model 220 (e.g., federated learning training process for the model 220) and the set of CMRs 215 may be indicated or determined in a number of manners or implementations. For example, in some cases, the model 220 may be associated with one or more serving cells (e.g., ServingCell-IDs), one or more BWPs (e.g., BWP-IDs), one or more CMR resource set identifiers (e.g., CSI-RS resource IDs, SSB resource IDs) for the federated learning process, or any combination thereof. In such cases, the association between the model 220 and the corresponding set of CMRs 215 may be signaled to the network nodes 115-a, 115-b, 115-c in a number of implementations.

For example, the association between the model 220 and the corresponding set of CMRs 215 may configured together with the configurations for federated learning training processes. In other cases, the association between the model 220 and the corresponding set of CMRs 215 may be configured separately from the configurations for federated learning training process, and may be indicated via RRC signaling, triggered via DCI and/or MAC-CE signaling, or both. Moreover, in some cases, the association between the model 220 and the corresponding set of CMRs 215 may configured or indicated based on associations with a respective CSI reporting configuration (e.g., CSI report setting, certain or specific CSI resource setting), such that the CMRs 215 (e.g., CSI-RS/SSB resources) associated with the respective CSI reporting configuration may be considered as the CMRs 215 for the federated learning training process.

In some aspects, inputs to the model 220 may include spatial/time-domain down sampled channel characteristics measurements (e.g., L1-RSRP measurements, L1-SINR measurements, rank indicators (RIs), precoding matrix indicators (PMIs), channel quality indicators (CQIs)) of a first quantity of the set of CMRs 215 (e.g., first quantity of CSI-RS resources/SSB resources associated with the model 220). For example, as shown in FIG. 2, the second network node 115-b may receive reference signals (e.g., CSI-RSs, SSBs) within the set of CMRs 215, and may perform measurements 225 for a first quantity of the set of CMRs 215. The measurements 225 for the N1 CMRs 215 may include RSRP measurements, RIs, PMIs, CQIs, and the like. The first quantity/first subset of the set of CMRs 215 that are measured for inputs to the model 220 may be down-sampled in the time and/or spatial-domain such that the second network node 115-b does not perform a measurement 225 for every CMR 215.

Continuing with reference to FIG. 2, the measurements 225 performed on the first quantity/subset of the set of CMRs 215 may be input into the local model 220 at the second network node 115-a. In some aspects, the model 220 may be configured to generate one or more outputs, where the model outputs may include predicted channel characteristics of a second quantity/second subset of the set of CMRs 215 (e.g., CSI-RS resources, SSB resources) associated with model 220. In some cases, the predicted channel characteristics may or may not be spatial/time-domain down sampled. In other words, the second network node 115-a may be configured to input measurements 225 associated with a first subset of the set of CMRs 215, and the model 220 may output predictions 230 associated with a second subset of the set of CMRs 215. The predictions 230 may include or indicate parameters associated with the second subset of the set of CMRs 215, including predicted time-domain parameters, predicted spatial-domain parameters, or both. For instance, the predictions 230 may include predicted RSRP measurements for CMRs 215 that are scheduled to be performed at measurement occurrences (e.g., time instances) in the future (time-domain predictions), and/or predicted RSRP measurements for CMRs 215 that are scheduled to be performed using specified Tx beams at the first network node 105-a (spatial-domain predictions).

In the context of supervised learning, the loss function(s) for ML-model training may be calculated based on labeled data (e.g., labels 235), where the labeled data is determined based at least on actually measured channel characteristics associated with the predicted channel characteristics of the second quantity of the set of CMRs 215. In other words, after generating predictions 230 for the second subset of the set of CMRs 215, the second network node 115-a may perform actual measurements on the second subset N2, and may input the measurements on the second subset of CMRs as labels 235 to further train and refine the model. In this regard, the labels 235 may correspond to predictions 230 output by the model 220, where re-inputting the labels 235 into the model 220 may enable the model 220 to determine how accurately the model 220 predicted the beam characteristics for the second quantity/subset of CMRs, and further refine the model 220 for subsequent beam characteristic predictions.

Upon training a local model 220, each network node 115-a, 115-b, 115-c may feed back the trained models 220 or intermediate parameters (e.g., gradients) associated with the model training to the first network node 105-a, the additional network node 105-b, or both. Stated differently, the network node 115-a may transmit a first locally trained model 220 to the first network node 105-a, the network node 115-b may transmit a second locally trained model 220 to the first network node 105-a, and the network node 115-c may transmit a third locally trained model 220 to the first network node 105-a. In this example, the first network node 105-a may be configured to compile or aggregate the locally trained models 220, and generate an aggregate or composite model based on the respective locally trained models 220. The first network node 105-a may then return the aggregate/composite model to the network nodes 115-a, 115-b, 115-c so that each network node within the wireless communications system 200 is configured to utilize the same aggregate/composite model to perform beam characteristic prediction.

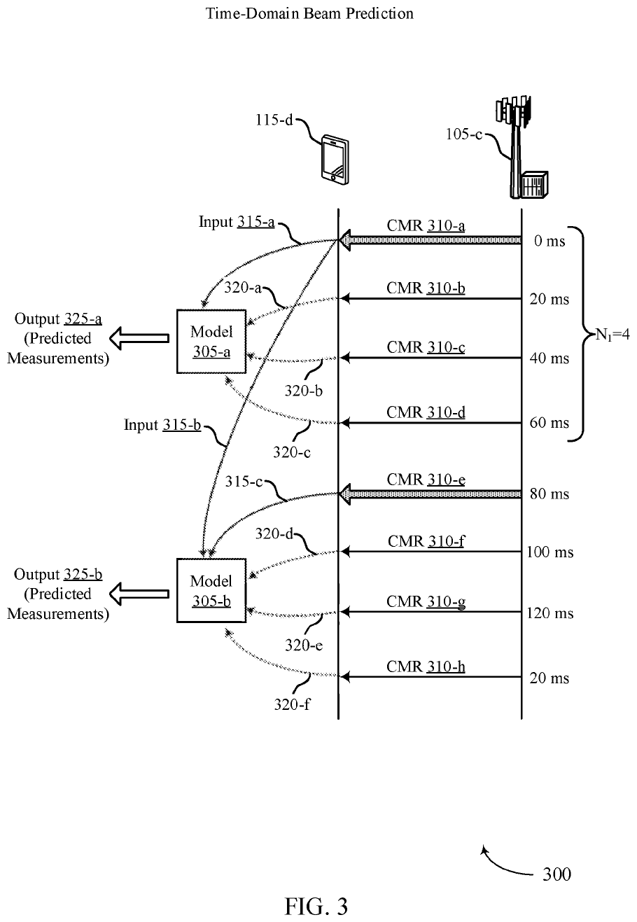

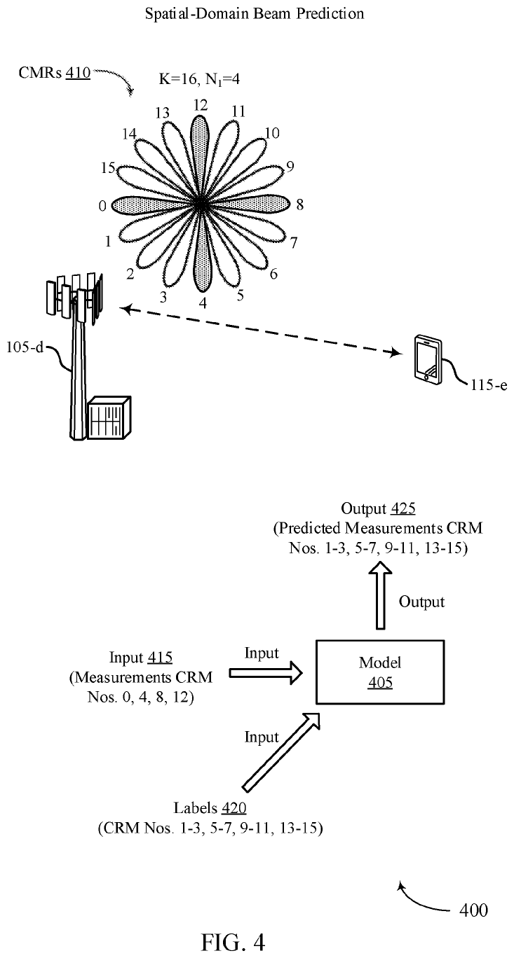

In some aspects, the model 220 training process illustrated in FIG. 2 may be used to predict time-domain parameters (e.g., time-domain measurement predictions) for the set of CMRs 215, to predict spatial-domain parameters (e.g., spatial-domain measurement predictions) for the set of CMRs 215, or both. Time-domain beam prediction will be described in further detail herein with respect FIG. 3, and spatial-domain beam prediction will be described in further detail herein with respect to FIG. 4.

While much of the description of the wireless communications system 200 is described in the context of the network nodes 115-a, 115-b, and 115-c training models 220 locally, and the first network node 105-a re-distributing an aggregate/composite model based on the locally trained models 220, this is not to be regarded as a limitation of the present disclosure, unless noted otherwise herein. In particular, in some cases, the network nodes 115-a, 115-b, 115-c may simply receive, download, or otherwise acquire a trained model 220 from the network (e.g., via the first network node 105-a and/or the additional network node 105-b), such that the network nodes 115-a, 115-b, and 115-c do not perform any training, but rather use the trained models 220 for predicting future time and spatial-domain characteristics for the set of CMRs 215 (e.g., exclusively for predicting future time and spatial-domain characteristics for the set of CMRs 215). In such cases, due to the fact that the network nodes 115 do not perform any training, the network nodes 115 may thereby ignore or otherwise refrain from inputting labels 235 into the model 220.

In cases where the network nodes 115-a, 115-b, and 115-c receive, download, or obtain trained models 220, the input measurements 225 and the predictions 230 (e.g., outputs) for the trained model 220 may be configured together when the respective network nodes 115 receive, download, or otherwise obtain the trained model 220. Additionally, or alternatively, the input measurements 225 and the predictions 230 for the trained model 220 may be configured separately from the time when the respective network nodes 115 receive or download the trained model 220. In such cases, the input measurements 225 and predictions 230 of the trained model 220 may be configured by the first network node 105-a via RRC signaling, activated or triggered via DCI and/or MAC-CE, or both. In additional or alternative implementations, the input measurements 225 and the predictions 230 for the trained model 220 may be configured based on associations with a respective CSI reporting configuration (e.g., CSI report setting, CSI resource setting), such that the set of CMRs 215 (e.g., set of CSI-RS/SSB resources) associated with the respective CSI reporting configuration may be considered as the CMRs 215 for the trained model 220 inference/prediction process used for predicting time and spatial-domain parameters, as described herein.

FIG. 3 shows an example of a model training procedure 300 that supports techniques for beam characteristic prediction using federated learning processes in accordance with one or more aspects of the present disclosure. In some examples, aspects of the model training procedure 300 may implement, or be implemented by, aspects of the wireless communications system 100, the wireless communications system 200, or both. In particular, the model training procedure 300 illustrates the use of a model 305 for performing time-domain beam prediction, as described with reference to FIGS. 1-2, among other aspects.

The model training procedure 300 illustrated in FIG. 3 includes a first network node 115-d and a second network node 105-c, which may be examples of other network nodes described herein. For example, the first network node 115-d illustrated in FIG. 3 may include an example of a UE 115 and/or the network node 115-a illustrated in FIG. 2. Similarly, the second network node 105-c illustrated in FIG. 3 may include an example of a network entity 105, a base station, and/or the first network node 105-a illustrated in FIG. 2.

As described previously herein, the first network node 115-d may be configured with, retrieve, download, or otherwise receive a model 305 (e.g., federated learning model, distributed learning model, machine learning model). In some cases, the first network node 115-d may receive the model 305 from the second network node 105-c, an additional network node (e.g., a server), or both. The model 305 may be usable for predicting at least time-domain characteristics associated with a set of CMRs 310. In this regard, the model 305 may be associated with the set of CMRs 310 illustrated in FIG. 3. The set of CMRs 310 may include CSI-RS resources, SSB resources, or both.

For example, as shown in FIG. 3, the set of CMRs 310 (e.g., set of CSI-RS/SSB resources) may be periodic or semi-persistent, and may include K quantity of CMRs 310. The CMRs 310 illustrated in FIG. 3 are illustrated with a periodicity of 20 ms. However, the set of CMRs 310 may be associated with any periodicity, or no periodicity (e.g., aperiodic).

In this example, the first network node 115-d may be configured to receive reference signals (e.g., CSI-RSs, SSBs) within a first quantity or first subset of the K quantity of CMRs 310, perform measurements (e.g., RSRP measurements, RIs, PMIs, CQIs) on the first quantity of CMRs 310, and use the measurements as inputs 315 for the model 305. For instance, as shown in FIG. 3, the first network node 115-d may perform a measurement for the first CMR 310-a, and may use the measurement as an input 315-a which is input into the model 305-a (e.g., input into a first version of the model 305-a). In this example, the model 305-a may be configured to generate an output 325-a, where the output 325-a includes predicted time-domain parameters of the set of CMRs 310. For instance, the output 325-a may include predicted RSRP measurements for the second CMR 310-b, the third CMR 310-c, and the fourth CMR 310-d.

In some aspects, the time-domain down-sampled channel characteristics measurements of the first quantity of the set of CMRs 310 may be determined based on the periodicity P of the set of CMRs 310, an integer factor N₁, or both. In other words, the periodicity may determine which subset of the set of CMRs 310 are to be measured for inputs 315 to the model 305, and which subset of the set of CMRs 310 are to be predicted via the output 325 of the model 305. For example, the first network node 115-d may determine the periodicity P of the set of CMRs 310 (e.g., periodicity of the periodic or semi-persistent CSI-RS or SSB resources) and the network-configured integer factor N₁, such that the channel characteristics of the first quantity/first subset of the set of CMRs 310 are identified in occasions with respect to every, at or least some, N₁×P instances/measurement occurrences of the set of CMRs 310 (e.g., time-domain down-sampled with factor N₁ relative to the set of periodic/semi-persistent CSI-RS/SSB resources). Stated differently, the first network node 115-c may determine which subset of CMRs 310 are to be measured as inputs 315 to the model 305 based on the periodicity P (e.g., 20 ms) and the integer factor N₁, which may be indicated by the second network node 105-c.

The first quantity (first subset) of CMRs 310 that are to be measured as inputs 315 to the model 305 may be equal to or less than K, where K represents the quantity of CMRs 310. If the first quantity or first subset of CMRs 310 that are measured is less than K, the machine-learning trained model 305 trained via federated learning may also be run or implemented at the second network node 105-c (based on L1-RSRP feedbacks). Additionally, or alternatively, the first quantity/first subset of the set of CMRs 310 that are to be measured as inputs 315 may be determined based on the measured best channel qualities (e.g., strongest L1-RSRP or L1-SINR, highest CQI, greatest RI). In such cases, the inputs 315 for the model 305 may include the identifiers (e.g., identifiers, indices, or other information indicative of CMR identification) of the respective CMRs 310 which were measured (e.g., identifiers of the CMRs 310 included in the first quantity/subset of CMRs 310 which are measured for inputs 315). For example, the input 315-a may include an identifier associated with the first CMR 310-a (e.g., an identifier associated with the first CMR 310-a, an index associated with the first CMR 310-a, or other information indicative of identification of the first CMR 310-a) that was measured for input to the model 305.

Continuing with the same example, the output 325-a may indicate predicted measurements for at least a portion of a second quantity (e.g., second subset) of the set of CMRs 310. For example, the output 325-a may include a first predicted RSRP measurement for the second CMR 310-b, a second predicted RSRP measurement for the third CMR 310-c, and a third predicted RSRP measurement for the fourth CMR 310-d. In some cases, the first network node 115-d, the second network node 105-c, or both, may utilize the output 325-a (e.g., predicted time-domain measurements) to select or modify parameters that are used to perform wireless communications between the respective devices.

In some aspects, the predicted channel characteristics of the second quantity of CMRs 310 (e.g., the predicted time-domain characteristics of the output 325-a) may be based on a number of factors or parameters. In particular, which CMRs 310 are predicted via the output 325-a may be based on a number of factors or parameters.

In some cases, the predicted channel characteristics of the second quantity of CMRs 310 may be based on the periodicity P associated with the set of CMRs 310 (e.g., periodic or semi-persistent CSI-RS/SSB resources), and a network-configured integer factor N₂. In such cases, the predicted channel characteristics (e.g., output 325-a) of the second quantity of CMRs 310 may be identified by occasions with respect to a consecutive number of N₂×P instances/measurement occurrences of the set of CMRs 310, where the first predicted CMR 310 instance/occasion is right after the last occasion identified from the channel characteristics measurements associated with the first quantity of CMRs 310. For example, in some cases, the second network node 105-c may indicate, to the first network node 115-d, the integer value N₂, and where the integer value N₂ and the periodicity P determine which CMRs 310 will be predicted via the model 305-a for the output 325-a.

In some aspects, the second quantity of CMRs 310 estimated via the outputs 325 may be equal to or smaller than K, where K represents the quantity of CMRs 310. That is, the model 305 may be configured to predict measurements for every CMR 310, or only a subset of the remaining CMRs 310. In cases where the second quantity of CMRs 310 predicted by the model 305 is smaller than K, the machine learning model 305 trained via federated learning may be run or executed at the first network node 115-d to report the predicted channel characteristics with reduced model complexity and/or reporting overhead. For example, if the model 305-a is exclusively (e.g., only) configured to predict measurements for the third CMR 310-c (as opposed to predicting measurements for each of the CMRs 310-b, 310-c, 310-d), the model 305-a may be executed with less power consumption and processing resources at the first network node 115-d.

Moreover, in some cases, the second quantity of CMRs 310 estimated via the outputs 325 may be determined based on predicted channel qualities of the respective CMRs 310 (e.g., strongest L1-RSRP, strongest L1-SINR, highest CQI, greatest RI). In such cases, the outputs 325 of the model 305 may include the identifiers of the CMRs 310 (e.g., identifiers associated with the CMRs 310, indices associated with the CMRs 310, or other information indicative of identification of the CMRs 310) reported via the outputs 325. For example, in cases where the model 305-a receives the input 315-a, the model 305-a may predict that the fourth CMR 310-d will have the best channel quality (e.g., a strongest signal strength), and may therefore include predicted measurements and an identifier associated with the fourth CMR 310-d.

In some cases, the first network node 115-d may be configured to perform measurements (e.g., RSRP, RI, PMI, CQI) on the second quantity/subset of CMRs 310, and use the measurements performed on the second quantity of CMRs 310 as labels 320 which are input back into the model 305 to facilitate training. For example, the first network node 115-d may measure a signal received via the second CMR 310-b, and input the measurement as a label 320-a into the model 305-a. Similarly, the first network node 115-d may measure signals received via the third CMR 310-c and the fourth CMR 310-c, and input the measurements as a labels 320-b and 320-c, respectively, into the model 305-a. The labels 320-a, 320-b, 320-c may include identifiers (e.g., identifiers, indices, or other information indicative of CMR identification) associated with the respective CMRs 310-b, 310-c, 310-d. By inputting the labels 320 into the model 305, the model 305 may be configured to compare the predicted measurements for the CMRs 310-b, 310-c, 310-d to the actually-performed measurements (e.g., labels 320-a, 320-b, 320-c) to further train and refine the model 305 to predict time-domain parameters for the set of CMRs 310. For example, the label 320-a may be compared to the predicted measurement of the CMR 310-b within the output 325-a. Similarly, the labels 320-b and 320-c may be compared to the predicted measurements of the CMR 310-c and 310-d, respectively, within the output 325-a.

In some aspects, the actually measured channel characteristics (e.g., data labels 320) associated with the predicted channel characteristics (e.g., predicted characteristics within the outputs 325) with respect to the second quantity of CMRs 310 predicted via the outputs 325 may be based on the same integer factor N₂ and channel characteristic instances, occasions, or occurrences predicted via the outputs 325. That is, if the model 305 is configured to predict channel characteristics for the CMRs 310-b and 310-d, the first network node 115-d may be configured to input labels 320-a and 320-c corresponding to the CMRs 310-b and 310-d.

Moreover, in cases where the second quantity of CMRs 310 predicted via the outputs 325 is smaller than K, as discussed previously herein, the actually measured channel characteristics (e.g., labels 320) may be identified with the measured best channel qualities associated with the second quantity of CMRs 310 (e.g., labels 320 corresponding to the strongest L1-RSRP, strongest L1-SINR, highest CQI, greatest RI), where the labels 320 may include the identifiers (e.g., identifiers, indices, or other information indicative of CMR identification) corresponding to the second quantity of CMRs 310. That is, if the model 305 is configured to generate outputs 325 which predict characteristics of the CMRs 310 with the two highest predicted channel qualities, the first network node 115-d may input labels 320 corresponding to the two CMRs 310 with the two highest predicted channel qualities, along with identifiers corresponding to the respective CMRs 310.

This process of measuring signals received via CMRs 310, providing the measurements as inputs 315 to the model 305, generating outputs 325 with the model 305, and providing labels 320 to the model 305 may occur iteratively. For example, as shown in FIG. 3, the first network node 115-d may measure a signal received via the CMR 310-e, and provide the measurement into a “second version” or “trained version” of the model 305-b as an input 315-c. In this regard, the model 305-b may be considered to be an updated or trained version of the model 305-a after inputting the labels 320-a, 320-b, 320-c to further train the model 305-a. Moreover, the measurement performed on the first CMR 310-a may additionally be provided to the model 305-b as an input 315-b. In the same manner, the model 305-b may generate an output 325-b including predicted time-domain measurements, which may include predicted measurements for the CMRs 310-f, 310-g, 310-h included in the second quantity, or second subset, of the CMRs 310. Further, actual measurements for the CMRS 310-f through 310-h may be inputs to the model 305-b as labels 320-d, 320-e, 320-f to further train and refine the model 305-b.

In some implementations, Rx beam information used by the first network node 115-d to receive signals within the respective CMRs 310 may additionally be used for the inputs 315 and labels 320, and predicted via the outputs 325. In other words, Rx beam information at the first network node 115-d may be utilized for model inputs, outputs, and data-labeling for the federated learning training process illustrated in FIG. 3. In particular, the Rx beams used for measuring the respective CMRs 310 for the first quantity of CMRs 310 may be indicated via the inputs 315. Moreover, the outputs 325 of the model 305 may include predicted Rx beam information associated with the predicted channel characteristics of the second quantity of CMRs 310 predicted via the outputs 325.

For example, the first network node 115-a may receive a reference signal (e.g., CSI-RS, SSB) via the first CMR 310-a via a first Rx beam, and may indicate the first Rx beam via the first input 315-a. Similarly, the first network node 115-a may receive a reference signal (e.g., CSI-RS, SSB) via the fifth CMR 310-e via a second Rx beam, and may indicate the second Rx beam via the second input 315-b. In this example, the first output 325-a may include predicted Rx beams for the CMRs 310-b, 310-c, and/or 310-d, and the second output 325-b may include predicted Rx beams for the CMRs 310-f, 310-g, and/or 310-h. In some aspects, predicted Rx beam information indicated via the outputs 325 may include Rx beams at the first network node 115-d which are predicted to exhibit the best or sufficient quality to receive signals via the respective predicted CMRs 310.

Further, in the context of supervised learning, the loss function(s) for machine learning-model training may be calculated based on labeled data that is based at least on actually used Rx beams that are used to receive and measure the second quantity of CMRs 310. Stated differently, the first network node 115-d may receive and measure signals received via the CMRs 310-b through 310-d, CMRs 310-f through 310-h using respective Rx beams, and may include identifiers associated with the Rx beams that were used within the labels 320-a through 320-f as inputs to the model 305 to further train the model to accurately predict which Rx beams should be used to receive signals via the set of CMRs 310. For example, the output 325-a may predict a first Rx beam that should be used for the second CMR 310-b. Subsequently, the first network node 115-d may receive a signal via the second CMR 310-b using a second Rx beam, and may include an identifier of the second Rx beam within the label 320-a. In this regard, the model 305-a may be configured to compare the predicted first Rx beam and the actually-used second Rx beam to further train the model 305 to perform time-domain beam prediction.

In some aspects, Rx beam information used as inputs/outputs/labels to the model 305 may be determined or indicated via implicit Rx beam information. In other words, the Rx beam information used for the inputs 315, the outputs 325, and/or the labels 320 may be identified implicitly based on a third quantity of CMRs 310 (e.g., third quantity of CSI-RS/SSB resources), a set of SRS resources, or both. In some aspects, the second network node 105-c may indicate the third quantity of CMRs 310 which are to be used for implicit determination of Rx beam information.

For example, in some cases, the Rx beams used for receiving signals via the CMRs 310 may be based on the respective CMRs 310. That is, the Rx beams associated with the CMRs 310 may be determined based on one or multiple CMRs 310 within the third quantity of CMRs 310, such as a CMR 310 that makes the Rx beam maximizing L1-RSRP among the third quantity of CMRs 310. In such cases, the inputs 315, outputs 325, and labels 320 for Rx beam information may be identified based on the associated CMRs 310.

By way of another example, in other cases, the Rx beams used for receiving signals via the CMRs 310 may be based on SRS information in combination with respective CMRs 310. That is, the Rx beams associated with the CMRs 310 may be determined based on one or multiple SRS resources associated with a set of SRS resources, where the Tx spatial filters (at the second network node 105-c) for respective SRS resource within the SRS resource set are determined by respective CMRs 310 of the third quantity of CMRs 310. In such cases, the inputs 315, the outputs 325, and the labels 320 for Rx beam information may be identified based on the associated SRS resource(s).

Additionally, or alternatively, Rx beam information used as inputs/outputs/labels to the model 305 may be determined or indicated via explicit Rx beam information. In other words, the Rx beams included within the inputs 315, outputs 325, and/or labels 320 may be identified explicitly (e.g., by the second network node 105-c) based on Rx beamform forming precoder information (e.g., phase/amplitude coefficients associated with respective radio frequency chains or phase shifters), antenna panel identifiers associated with the Rx beamforming precoder(s), orientation of the antenna panel associated with the Rx beamforming, target angle of arrival (AoA) and/or Zenith of arrival (ZoA) associated with the Rx beamforming, or any combination thereof.

As described previously herein, in some aspects, the first network node 115-d may transmit the trained model 305-b to the second network node 105-c. In particular, the second network node 105-c may compile multiple trained models 305 used for time-domain beam prediction from multiple network nodes, and may generate an aggregate or composite model based on the compiled locally-trained models 305. In such cases, the second network node 105-c may transmit the aggregate/composite model to the first network node 115-d (and other network nodes) so that each network node within the wireless communications system may utilize the same trained model for predicting time-domain characteristics associated with the set of CMRs 310.

FIG. 4 shows an example of a model training procedure 400 that supports techniques for beam characteristic prediction using federated learning processes in accordance with one or more aspects of the present disclosure. In some examples, aspects of the model training procedure 400 may implement, or be implemented by, aspects of the wireless communications system 100, the wireless communications system 200, the model training procedure 300, or any combination thereof. In particular, the model training procedure 400 illustrates the use of a model 405 for performing spatial-domain beam prediction, as described with reference to FIGS. 1-2, among other aspects.

While the model 305 illustrated in FIG. 3 is described in the context time-domain beam prediction, and the model 405 illustrated in FIG. 4 is described in the context spatial-domain beam prediction, the models may be the same in some implementations. In other words, in some cases, a network node (e.g., UE 115) may be configured to train a single model in accordance with both the model training procedures 300, 400 such that the model can be used for both time-domain and spatial-domain beam prediction.

The model training procedure 400 illustrated in FIG. 4 includes a first network node 115-e and a second network node 105-d, which may be examples of other network nodes described herein. For example, the first network node 115-e illustrated in FIG. 4 may include an example of a UE 115 and/or the network node 115-a illustrated in FIG. 2. Similarly, the second network node 105-d illustrated in FIG. 4 may include an example of a network entity 105, a base station, and/or the first network node 105-a illustrated in FIG. 2.

As described previously herein, the first network node 115-e may be configured with, retrieve, download, or otherwise receive a model 405 (e.g., federated learning model, distributed learning model, machine learning model). In some cases, the first network node 115-e may receive the model 405 from the second network node 105-d, an additional network node (e.g., a server), or both. The model 405 may be usable for predicting at least time-domain characteristics associated with a set of CMRs 410. In this regard, the model 405 may be associated with the set of CMRs 410 illustrated in FIG. 4. The set of CMRs 410 may include CSI-RS resources, SSB resources, or both.

For example, as shown in FIG. 4, the set of CMRs 410 (e.g., set of CSI-RS/SSB resources) may include K quantity of CMRs 410 with different spatial filters. In other words, the CMRs 410 illustrated in FIG. 4 may be separated in the spatial-domain, and may be associated with different spatial filters or Tx beams at the second network node 105-d.

In this example, the first network node 115-e may be configured to receive reference signals (e.g., CSI-RSs, SSBs) within a first quantity or first subset of the K quantity of CMRs 410, perform measurements (e.g., RSRP measurements, RIs, PMIs, CQIs) on the first quantity of CMRs 410, and use the measurements as inputs 415 for the model 405. For instance, as shown in FIG. 4, the first network node 115-e may perform a measurement for the CMRs 410 with CMR identifiers (e.g., CMR indices) 0, 4, 8, and 12. For example, the first network node 105-e may perform measurements on reference signals (e.g., CSI-RS, SSB) transmitted according to CMR #0, CMR #4, CMR #8, and CMR #12, and may include the measurements in an input 415 which is provided to the model 405.

In this example, the model 405 may be configured to generate an output 425, where the output 425 includes predicted spatial-domain parameters of the set of CMRs 410. For instance, the output 425 may include predicted RSRP measurements for at least a portion of the CMRs 410 which were not measured for the input 415. For example, the output 425 may include predicted RSRP measurements for the CMRs 410 with identifiers (e.g., indices) 1-3, 5-7, 9-11, and 13-15. In this regard, the first quantity of CMRs 410 associated with the input 415 may include CMRs #0, 4, 8, and 12, and the second quantity of CMRs 410 which are predicted via the output 425 may include CMRs #1-3, 5-7, 9-11, and 13-15.

In some aspects, the spatial-domain down-sampled channel characteristics measurements of the first quantity of the set of CMRs 410 measured for the input 415 may be determined based on an integer factor N₁, where N₁<K, where K represents the quantity of CMRs 410. In particular, the channel characteristics of the first quantity of CMRs 410 which are measured for the input 415 to the model 405 may include K/N₁ instances/occurrences of the CMRs 410. Stated differently, the CMRs 410 which are measured for the input 415 may be spatial-domain down sampled with factor N₁ with respect to the set of CMRs 410 illustrated in FIG. 4. In this regard, in some cases, the integer factor N₁ may indicate how many CMRs 410 are to be measured for the input 415 (e.g., how many CMRs 410 are included within the first quantity of CMRs 410). In some aspects, the second network node 105-d may indicate or signal the integer factor N₁ that is used to determine which CMRs 410 will be measured for the input 415.

Moreover, which CMRs 410 (e.g., CSI-RS resources and/or SSB resources) are included within the first quantity of CMRs 410 that are measured for the input 415 may be further configured by the network (e.g., by the second network node 105-d). For example, in the context of a CSI-RS resource set (e.g., set of CMRs 410) with CSI-RS resources 0 through 15 (e.g., K=16) (CMRs 410 with identifiers (e.g., indices) 0 through 15) and integer factor N₁=4 (e.g., four CMRs 410 to be measured for the input 415, or first quantity of CMRs 410 is equal to four), the network may configure the first quantity of CMRs 410 that are to be measured for the input 415 to be CSI-RS resources 0, 4, 8, and 12 (e.g., configures the first network node 115-e to measure CMRs #0, 4, 8, and 12).

Continuing with the same example, the output 425 may indicate predicted measurements for at least a portion of a second quantity (e.g., second subset) of the set of CMRs 410. For example, the output 425 may include a first predicted RSRP measurement for CMR 1, a second predicted RSRP measurement for the CMR 2, a third predicted RSRP measurement for CMR 3, etc. In some cases, the first network node 115-e, the second network node 105-d, or both, may utilize the output 425 (e.g., predicted time-domain measurements) to select or modify parameters that are used to perform wireless communications between the respective devices.

In some aspects, the predicted channel characteristics of the second quantity of CMRs 410 (e.g., the predicted time-domain characteristics of the output 425) may be based on a number of factors or parameters. In particular, which CMRs 410 are predicted via the output 425 may be based on a number of factors or parameters.

In some cases, the second quantity of CMRs 410 which are predicted via the output 425 may include each CMR 410 of the full set of CMRs 410 except those which were included within the first quantity of CMRs 410 and measured for the input 415.

Stated differently, in some cases, the output 425 may predict spatial-domain parameters/characteristics for each of the CMRs 410 which were not measured for the input 415, and may therefore predict spatial-domain parameters for CMRs #1-3, 5-7, 9-11, and 13-15.

In additional or alternative implementations, the output 425 may predict spatial-domain parameters for only a portion of the CMRs 410 which were not measured for the input 415. Stated differently, the second quantity of CMRs 410 predicted via the output 425 may include a subset of the CMRs 1-3, 5-7, 9-11, and 13-15. In some aspects, which CMRs 410 are predicted via the output 425 may be based on a network-configured integer factor N₂. In particular, the second quantity of CMRs 410 which are predicted via the output 425 may include [K/N2] instances/occurrences (e.g., only [K/N₂] instances of the set of CMRs 410 are predicted via the output 425). In such cases, the integer factor N₂ may be signaled by the second network node 105-d.

Additionally, or alternatively, the second quantity of CMRs 410 estimated via the outputs 425 may be determined based on predicted channel qualities of the respective CMRs 410 (e.g., strongest L1-RSRP, strongest L1-SINR, highest CQI, greatest RI). In such cases, the outputs 325 of the model 405 may include the identifiers of the CMRs 410 (e.g., identifiers associated with the CMRs 410, indices associated with the CMRs 410, or other information indicative of identification of the CMRs 410) reported via the outputs 425. For example, in cases where the model 405-a receives the input 415, the model 405 may predict that the fourth CMR 410 (CMR 3) will have the best channel quality, and may therefore include predicted measurements and an identifier associated with the CMR #3. For example, in the context of a CSI-RS resource set (e.g., set of CMRs 410) with CSI-RS resources 1 through 16 (i.e., K=16), N1=4 (e.g., four CMRs 410 measured for the input 415, or first quantity of CMRs is four), and N2=4 (e.g., four CMRs 410 predicted via the output 425, or second quantity of CMRs is four), the second network node 105-d may configure that the first quantity of CSI-RS resources that are measured for the input include are CSI-RS resources #1, 5, 9, and 13 (e.g., CMRs #1, 5, 9, and 13 are measured for the input 415), and the second quantity of CSI-RS resources are four CRI-RS resources including predicted L1-RSRPs being the strongest among CSI-RS resources #2-4, 6-8, 10-12, 14-16.

In some cases, the first network node 115-e may be configured to perform measurements (e.g., RSRP, RI, PMI, CQI) on the second quantity/subset of CMRs 410, and use the measurements performed on the second quantity of CMRs 410 as labels 420 which are input back into the model 405 to facilitate training. For example, the first network node 115-e may measure a signal received via the second CMR 410 (e.g., CMR #1), and input the measurement as a label 420 into the model 405. Similarly, the first network node 115-e may measure signals received via the third and fourth CMRs 410 (e.g., CMRs #2 and 3), and input the measurements as a labels 420 into the model 405. The labels 420 may include identifiers associated with the respective CMRs 410 (e.g., label 420 for CMR #1 may include an identifier associating the label 420 to CMR #1). As described herein, an identifier may be an index or other information indicative of the association between a label and a CMR. By inputting the labels 420 into the model 405, the model 405 may be configured to compare the predicted measurements for the CMRs 410 to the actually-performed measurements (e.g., labels 420) to further train and refine the model 405 to predict spatial-domain parameters for the set of CMRs 410. For example, the label 420 for CMR #1 may be compared to the predicted measurement for CMR #1 within the output 425.

In some aspects, the actually measured channel characteristics (e.g., data labels 420) associated with the predicted channel characteristics (e.g., predicted characteristics within the output 425) with respect to the second quantity of CMRs 410 predicted via the output 425 may be based on the same integer factor N₂ and channel characteristic instances/occasions predicted via the output 412. That is, if the model 405 is configured to predict channel characteristics for the CMRs #1-3 and 9-11, the first network node 115-e may be configured to input labels 420 corresponding to the CMRs #1-3 and 9-11.

Moreover, in cases where the second quantity of CMRs 410 predicted via the output 425 is smaller than K, as discussed previously herein, the actually measured channel characteristics (e.g., labels 320) may be identified with the measured best channel qualities associated with the second quantity of CMRs 410 (e.g., labels 420 corresponding to the strongest L1-RSRP, strongest L1-SINR, highest CQI, greatest RI), where the labels 420 may include the identifiers of the second quantity of CMRs 410. That is, if the model 405 is configured to generate outputs 425 which predict characteristics of the CMRs 410 with the two highest predicted channel qualities, the first network node 115-e may input labels 420 corresponding to the two CMRs 410 with the two highest predicted channel qualities, along with identifiers corresponding to the respective CMRs 410.

In some implementations, Rx beam information used by the first network node 115-e to receive signals within the respective CMRs 410 may additionally be used for the inputs 415 and labels 420, and predicted via the outputs 425. In other words, Rx beam information at the first network node 115-e may be utilized for model inputs, outputs, and data-labeling for the federated learning training process illustrated in FIG. 4. In particular, the Rx beams used for measuring the respective CMRs 410 for the first quantity of CMRs 410 may be indicated via the inputs 415. Moreover, the outputs 425 of the model 405 may include predicted Rx beam information associated with the predicted channel characteristics of the second quantity of CMRs 410 predicted via the outputs 425.

For example, the first network node 115-a may receive a reference signal (e.g., CSI-RS, SSB) via the CMR #6 via a first Rx beam, and may indicate the first Rx beam via the first input 415. In this example, the output 425 may include a predicted Rx beam for the CMR #6 (e.g., predicted Rx beams which are predicted to exhibit the best or sufficient quality to receive signals via the CMR #6).

Further, in the context of supervised learning, the loss function(s) for machine learning-model training may be calculated based on labeled data that is based at least on actually used Rx beams that are used to receive and measure the second quantity of CMRs 410. Stated differently, the first network node 115-e may receive and measure signals received via the second quantity of CMRs 410 (e.g., CMRs #1-3, 5-7, 9-11, and 13-15) using respective Rx beams, and may include identifiers associated with the Rx beams that were used within the labels 420 as inputs to the model 405 to further train the model to accurately predict which Rx beams should be used to receive signals via the set of CMRs 410. In this regard, the model 405-a may be configured to compare the predicted Rx beams within the output 425 and actually-used Rx beams within the labels 420 to further train the model 405 to perform spatial-domain beam prediction.

In some aspects, Rx beam information used as inputs/outputs/labels to the model 405 may be determined or indicated via implicit Rx beam information, explicit Rx beam information, or both, as described with reference to the model training procedure 300 in FIG. 3. In this regard, any description associated with the use of Rx beam information used as inputs, outputs, and labels in FIG. 3 may additionally be understood to apply to the model training procedure 400 in FIG. 4, unless described otherwise herein.

As described previously herein, in some aspects, the first network node 115-e may transmit the trained model 405 to the second network node 105-d. In particular, the second network node 105-d may compile multiple trained models 405 used for time-domain beam prediction from multiple network nodes, and may generate an aggregate or composite model based on the compiled locally-trained models 405. In such cases, the second network node 105-d may transmit the aggregate/composite model to the first network node 115-e (and other network nodes) so that each network node within the wireless communications system may utilize the same trained model for predicting time-domain characteristics associated with the set of CMRs 410.

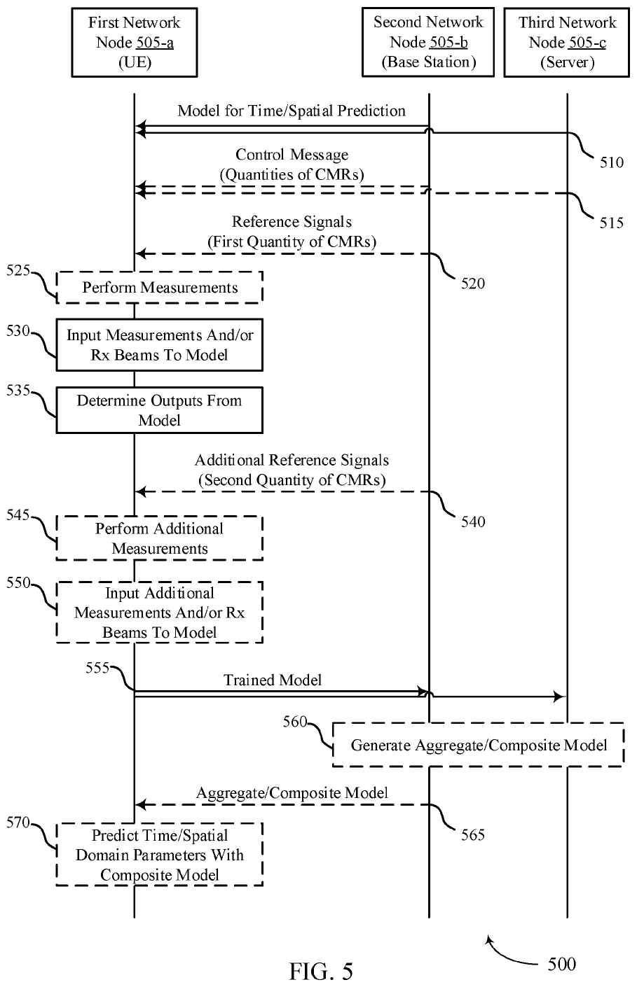

FIG. 5 shows an example of a process flow 500 that supports techniques for beam characteristic prediction using federated learning processes in accordance with one or more aspects of the present disclosure. In some examples, aspects of the process flow 500 may implement, or be implemented by, aspects of the wireless communications system 100, the wireless communications system 200, the model training procedure 300, the model training procedure 400, or any combination thereof. In particular, the process flow 500 illustrates a federated learning training process for training a model associated with a set of CMRs to predict time-domain and/or spatial-domain parameters of the set of CMRs, as described with reference to FIGS. 1-4, among other aspects.

The process flow 500 may include a first network node 505-a (e.g., a UE 115), a second network node 505-b (e.g., network entity 105, base station), and a third network node 505-c (e.g., server), which may be examples of UEs 115, network entities 105, and servers as described with reference to FIGS. 1-4.

In some examples, the operations illustrated in process flow 500 may be performed by hardware (e.g., including circuitry, processing blocks, logic components, and other components), code (e.g., software) executed by a processor, or any combination thereof. Alternative examples of the following may be implemented, where some steps are performed in a different order than described or are not performed at all. In some cases, steps may include additional features not mentioned below, or further steps may be added.

At 510, the first network node 505-a may receive a model for predicting time and/or spatial characteristics associated with a set of CMRs. In other words, the first network node 505-a may receive a model (e.g., federated learning model, distributed learning model, machine learning model) that corresponds to a set of CMRs, where the model is usable for predicting time and/or spatial characteristics associated with the set of CMRs. The set of CMRs may include a set of CSI-RS resources, SSB resources, or both.

The first network node 505-a may receive, download, or otherwise obtain the model from the second network node 505-b, the third network node 505-c, or both. In some aspects, the model may be untrained such that the first network node 505-a is configured to train the local model. Additionally, or alternatively, the first network node 505-a may receive a trained model such that the first network node 505-a is able to perform time/spatial-domain prediction without any training at the first network node 505-a.

In some aspects, the model may be associated with one or more serving cells, one or more BWPs, one or more CSI resource sets, a CSI reporting configuration, or any combination thereof. In some cases, the second network node 505-b, the third network node 505-c, or both, may indicate (e.g., via control signaling) the serving cell(s), BWP(s), CSI resource set(s), and/or CSI reporting configuration(s) associated with the model. The association between the model and the CSI reporting configuration may be configured along with the model, or signaled to the first network node 505-a separately from the model (e.g., via RRC, DCI, MAC-CE). Additionally, or alternatively, the model may be configured along with a CSI reporting configuration (e.g., CSI reports setting, CSI resource setting).

At 515, the first network node 505-a may receive, from the second network node 505-b, the third network node 505-c, or both, a control message indicating quantities or subsets of CMRs that are to be measured as inputs for the model and/or predicted as outputs for the model. The first network node 505-a may receive the control message at 515 based on receiving the model at 510.

For example, the control message may indicate a first quantity (e.g., first subset) of CMRs that are to be measured as inputs for the model. For instance, the control message may indicate the first CMR 310-a and the fifth CMR 310-e illustrated in FIG. 3 are to be measured for time-domain prediction, or may indicate that CMRs #0, 4, 8, and 12 illustrated in FIG. 4 are to be measured for spatial-domain prediction. Similarly, the control message may indicate a second quantity (e.g., second subset) that are to be predicted for outputs of the model. For instance, the control message may indicate which of the CMRs 310-b through 310-d and/or CMRs 310-f through 310-h illustrated in FIG. 3 are to be predicted as outputs of the model, or which of CMRs #1-3, 5-7, 9-11, and 13-15 illustrated in FIG. 4 are to be predicted as outputs of the model.

In some cases, the first quantity/subset of CMRs, the second quantity/subset of CMRs, or both, may be determined based on a periodicity associated with the set of CMRs, integer factors (e.g., N₁, N₂) indicated by the second network node 505-b, or both. For example, the first network node 505-a may determine the periodicity P of the set of CMRs (e.g., periodicity of the periodic or semi-persistent CSI-RS or SSB resources) and an integer factor N₁ indicated by the second network node 505-b, such that the channel characteristics of the first quantity/first subset of the set of CMRs are identified in occasions with respect to every N₁×P measurement occurrences (e.g., instances) of the set of CMRs (e.g., time-domain down-sampled with factor N₁ relative to the set of periodic/semi-persistent CSI-RS/SSB resources). By way of another example, in some cases, the second network node 505-b may indicate, to the first network node 505-b, the integer value N₂, and where the integer value N₂ and the periodicity P determine which CMRs will be predicted as outputs by the model.

At 520, the first network node 505-a may receive, from the second network node 505-b, a first set of reference signals (e.g., CSI-RSs, SSBs) via the first quantity of CMRs. The first network node 505-a may receive the first set of reference signals at 520 based on receiving the model at 510, receiving the control message at 515, or both. For example, in cases where the control message at 515 indicates the first quantity of CMRs that are to be measured for inputs to the model, the first network node 505-a may receive the first set of reference signals at 520 based on the control message.

In some aspects, the first network node 505-a may receive the first set of reference signals via the first quantity of CMRs using a first set of Rx beams at the first network node 505-a. The first set of Rx beams used to receive the reference signals at 520 may be implicitly or explicitly determined or indicated, as described previously herein with respect to FIG. 2. Moreover, as will be described in further detail herein, the model may be configured to receive Rx beam information as inputs, and predict Rx beam information as outputs.

At 525, the first network node 505-a may perform measurements on the first set of signals received via the first quantity (e.g., first subset) of CMRs at 520. In other words, the first network node 505-a may obtain first measurement information. In this regard, the first network node 505-a may perform the measurements at 525 based on receiving the model at 510, receiving the control message at 515, receiving the reference signals at 520, or any combination thereof. The measurements may include RSRP measurements, SNR measurements, SINR measurements, CQIs, RIs, PMIs, or any combination thereof.

At 530, the first network node 505-a may input measurements performed at 525 into the model. For example, in cases where the first network node 505-a performs RSRP measurements and determines PMIs for the first quantity of CMRs at 525, the first network node 505-a may input the RSRP measurements and PMIs into the model.

Moreover, in some implementations, the first network node 505-a may be configured to input Rx beam information into the model. In other words, the network node 505-a may input a first of beam identifiers corresponding to a first set of beams into a model, where the first set of beams include the first set of signals. For example, the first network node 505-a may input identifiers associated with the first set of Rx beams that were used to receive the reference signals via the first quantity of CMRs at 520. For instance, referring to FIG. 3, the first network node 505-a may input Rx beams used to receive the first CMR 310-a into the model 305-a. In such cases, the first network node 505-a may include identifiers which indicate which Rx beams correspond to which measurements/which CMRs. Accordingly, the first network node 505-a may input the measurements and/or Rx beam information into the model at 530 based on receiving the model at 510, receiving the control message at 515, receiving the reference signals at 520, performing the measurements at 525, or any combination thereof.

At 535, the first network node 505-a may determine a set of parameters associated with the second quantity of CMRs as an output of the model. In particular, the model may be configured to perform time and spatial-domain prediction for the second quantity (e.g., second subset) of CMRs based on the inputs (e.g., measurements, Rx beams) to the model at 530. In this regard, the set of parameters associated with the second quantity of CMRs which are output from the model may include one or more predicted time-domain parameters, one or more predicted spatial-domain parameters, or both. In the context of predicted time-domain parameters, the first quantity of CMRs and the second quantity of CMRs include CMRs associated with a first set of measurement occurrences (e.g., time instances) and a second set of measurement occurrences (e.g., time instances), respectively, and the predicted time-domain parameters include predicted measurements associated with the second quantity of CMRs within the second set of measurement occurrences (e.g., time instances). Similarly, in the context of predicted spatial-domain parameters, the first quantity of CMRs and the second quantity of CMRs include CMRs associated with a first set of spatial filters and a second set of spatial filters at the second network node 505-b, respectively, and the predicted time-domain parameters include predicted measurements associated with the second quantity of CMRs within the second set of spatial filters.

For example, referring to FIG. 3, the model 305-a may predict measurements (e.g., time-domain parameters) associated with CMR 310-b, CMR 310-c, CMR 310-c, or any combination thereof. Similarly, referring to FIG. 4, the model 405 may predict measurements (e.g., spatial-domain parameters) associated with the CMRs #1-3, 5-7, 9-11, 13-15, or any combination thereof. In other words, an additional output of a model may be predicted information including a second set of beam identifiers (e.g., spatial-domain parameters) that correspond to a second set of beams (e.g., different, at least in part, from the first set of beams) and the second set of beams may be associated with a second quantity of CMRs. Moreover, in these example, the outputs from the model may include predicted measurements associated with the second quantity of CMRs, including RSRP measurements, predicted RIs, predicted CQIs, predicted SNR/SINR measurements, predicted RIs, or any combination thereof.

In some aspects, the output from the model at 535 may additionally or alternatively include predicted Rx beam information associated with the second quantity of CMRs. For example, in cases where the first network node 505-a inputs Rx beams used to receive the reference signals via the first quantity of CMRs, the output at 535 may include predicted Rx beams associated with the second quantity of CMRs (e.g., Rx beams predicted to have the highest or sufficient quality for receiving signals via the second quantity of CMRs).

At 540, the first network node 505-a may receive, from the second network node 505-b, an additional set of reference signals (e.g., CSI-RSs, SSBs) via the second quantity of CMRs. In other words, first network node 505-a may receive reference signals via the second set of CMRs which were predicted via the output at 535. The first network node 505-a may receive the additional set of reference signals at 540 based on (e.g., in accordance with) the set of parameters (e.g., time/spatial-domain predictions) indicated in the output at 535.

For example, referring to FIG. 3, the first network node 505-a may receive a second set of reference signals via the second set of CMRs including CMRs 310-b, 310-c, 310-c, or any combination thereof, which were predicted via the output at 535. Similarly, referring to FIG. 4, the first network node 505-a may receive a second set of reference signals via the second set of CMRs including CMRs #1-3, 5-7, 9-11, 13-15, or any combination thereof, which were predicted via the output at 535.

The first network node 505-a may receive the additional set of reference signals at 540 based on receiving the model at 510, receiving the control message at 515, receiving the reference signals at 520, performing the measurements at 525, providing the inputs to the model at 530, determining the model outputs at 535, or any combination thereof. For example, in cases where the output of the model at 535 includes predicted Rx beams for the second quantity of CMRs, the first network node 505-a may receive the additional set of reference signals via the second quantity of CMRs using the predicted Rx beams. Additionally, or alternatively, the first network node 505-a may use different Rx beams than the predicted Rx beams for receiving the additional reference signals at 540.

At 545, the first network node 505-a may perform additional measurements (e.g., obtain additional measurement information) on the additional set of signals received via the second quantity (e.g., second subset) of CMRs at 540. In other words, the first network node 505-a may perform measurements on the second set of CMRs which were predicted for time/spatial-domain parameters via the output of the model at 535. In this regard, the first network node 505-a may perform the measurements at 545 based on receiving the model at 510, receiving the control message at 515, receiving the reference signals at 520, performing the measurements at 525, providing the inputs to the model at 530, determining the model outputs at 535, receiving the additional set of reference signals at 540, or any combination thereof. or any combination thereof. The measurements may include RSRP measurements, SNR measurements, SINR measurements, CQIs, RIs, PMIs, or any combination thereof.

At 550, the first network node 505-a may input the additional measurements performed at 545 into the model. In particular, the first network node 505-a may input the additional measurements into the model to further train the model. In some aspects, the first network node 505-a may input a set of identifiers associated with the additional set of measurements and the respective second quantity of channel measurement resources into the model so that the model may determine which measurements correspond to which CMRs.

For example, referring to FIG. 3, the first network node 505-a may perform additional measurements of the second quantity of CMRs (e.g., CMRs 310-a, 310-b, 310-c), and input the additional measurements into the model as labels 320 to further train the model to perform time-domain prediction for the set of CMRs. Similarly, referring to FIG. 4, the first network node 505-a may perform additional measurements of the second quantity of CMRs (e.g., CMRs #1-3, 5-7, 9-11, 13-15), and input the additional measurements into the model as labels 420 to further train the model to perform spatial-domain prediction for the set of CMRs.

Moreover, in some implementations, the first network node 505-a may be configured to input Rx beam information into the model. For example, the first network node 505-a may input identifiers associated with the additional set of Rx beams that were used to receive the additional set of reference signals via the second quantity of CMRs at 540. For instance, referring to FIG. 3, the first network node 505-a may input Rx beams used to receive signals via the second quantity of CMRs 310-b, 310-c, 310-d into the model 305-a. In such cases, the first network node 505-a may include identifiers which indicate which Rx beams correspond to which measurements/which CMRs.

At 555, the first network node 505-a may transmit the trained model (e.g., locally-trained model) to the second network node 505-b, the third network node 505-c, or both. In particular, the first network node 505-a may transmit the trained model at 555 based on performing the model training at steps 545 through 550. As such, in cases where the first network node 505-a receives, downloads, or otherwise obtains a trained model, the first network node 505-a may refrain from performing the model training at 545 through 550.

At 560, the second network node 505-b, the third network node 505-c, or both, may generate an aggregate/composite model based on the trained model received from the first network node 505-a at 555. In particular, the second network node 505-b and/or the third network node 505-c may aggregate trained models from multiple network nodes 505 including the first network node 505-a, and may generate the aggregate/composite model based on the received, locally-trained models. As such, the terms “aggregate model,” “composite model,” and like terms, may refer to a model that is based on two or more locally-trained models.

At 565, the first network node 505-a may receive the aggregate/composite model that was generated at 560. As such, the first network node 505-a may receive the aggregate/composite model at 565 based on (e.g., in response to) transmitting the locally-trained model at 555. Moreover, the second network node 505-b, the third network node 505-c, or both, may distribute the aggregate/composite model to multiple network node 505 (e.g., multiple UEs 115), for example, to each network node 505 which provided a locally-trained model.

At 570, the first network node 505-a may predict time-domain characteristics, spatial-domain characteristics, or both, associated with the set of CMRs using the aggregate/composite model. In other words, the first network node 505-a may perform measurements associated with a first subset of the set of CMRs, input the measurements (and/or corresponding Rx beams) into the aggregate/composite model, and predict time/spatial-domain parameters associated with a second subset of the set of CMRs using the aggregate/composite model, as described previously herein.

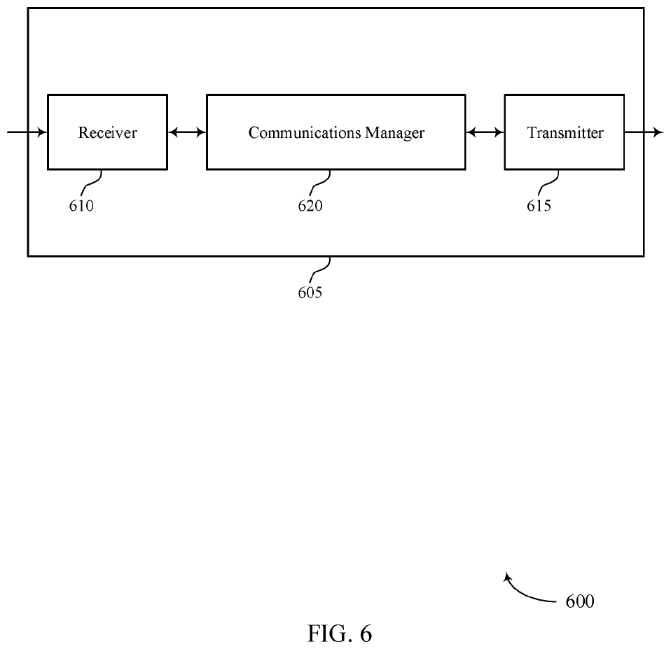

FIG. 6 shows a block diagram 600 of a device 605 that supports techniques for beam characteristic prediction using federated learning processes in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for beam characteristic prediction using federated learning processes). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for beam characteristic prediction using federated learning processes). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of techniques for beam characteristic prediction using federated learning processes as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a first network node in accordance with examples as disclosed herein. For example, the communications manager 620 may be configured as or otherwise support a means for receiving a first model configured to predict at least one of time-domain characteristics or spatial-domain characteristics associated with a set of channel measurement resources. The communications manager 620 may be configured as or otherwise support a means for generating first measurement information corresponding to a first quantity of channel measurement resources of the set of channel measurement resources, where the first quantity of channel measurement resources correspond to a first set of signals. The communications manager 620 may be configured as or otherwise support a means for inputting the first measurement information into the first model. The communications manager 620 may be configured as or otherwise support a means for obtaining, as an output of the first model, first predicted information corresponding to a second quantity of channel measurement resources of the set of channel measurement resources, where the first predicted information includes at least one of: one or more predicted time-domain parameters or one or more predicted spatial-domain parameters. The communications manager 620 may be configured as or otherwise support a means for receiving a second set of signals, where the second quantity of channel measurement resources correspond to the second set of signals.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced processing, reduced power consumption, and more efficient utilization of communication resources.

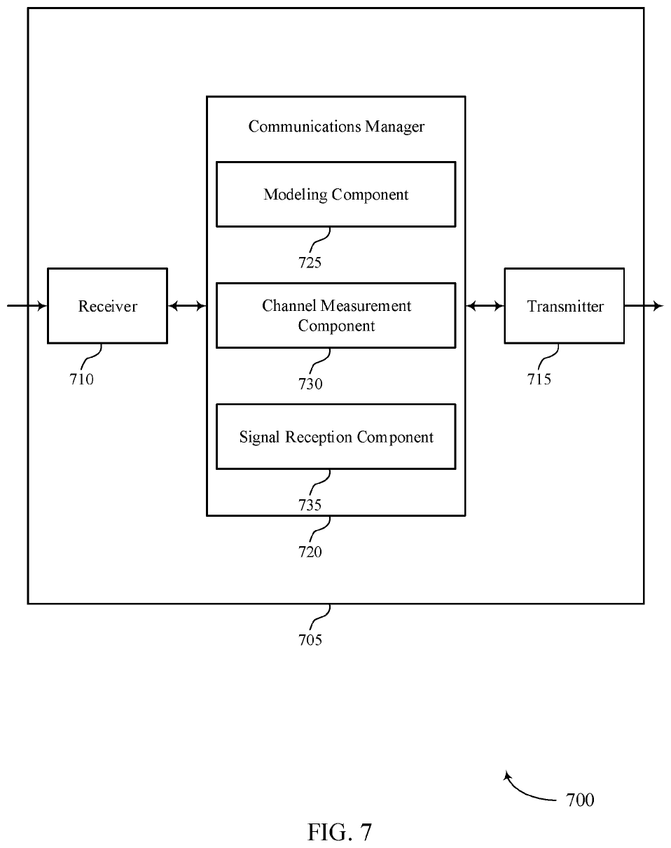

FIG. 7 shows a block diagram 700 of a device 705 that supports techniques for beam characteristic prediction using federated learning processes in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for beam characteristic prediction using federated learning processes). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for beam characteristic prediction using federated learning processes). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of techniques for beam characteristic prediction using federated learning processes as described herein. For example, the communications manager 720 may include a modeling component 725, a channel measurement component 730, a signal reception component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a first network node in accordance with examples as disclosed herein. The modeling component 725 may be configured as or otherwise support a means for receiving a first model configured to predict at least one of time-domain characteristics or spatial-domain characteristics associated with a set of channel measurement resources. The channel measurement component 730 may be configured as or otherwise support a means for generating first measurement information corresponding to a first quantity of channel measurement resources of the set of channel measurement resources, where the first quantity of channel measurement resources correspond to a first set of signals. The modeling component 725 may be configured as or otherwise support a means for inputting the first measurement information into the first model. The modeling component 725 may be configured as or otherwise support a means for obtaining, as an output of the first model, first predicted information corresponding to a second quantity of channel measurement resources of the set of channel measurement resources, where the first predicted information includes at least one of: one or more predicted time-domain parameters or one or more predicted spatial-domain parameters. The signal reception component 735 may be configured as or otherwise support a means for receiving a second set of signals, where the second quantity of channel measurement resources correspond to the second set of signals.

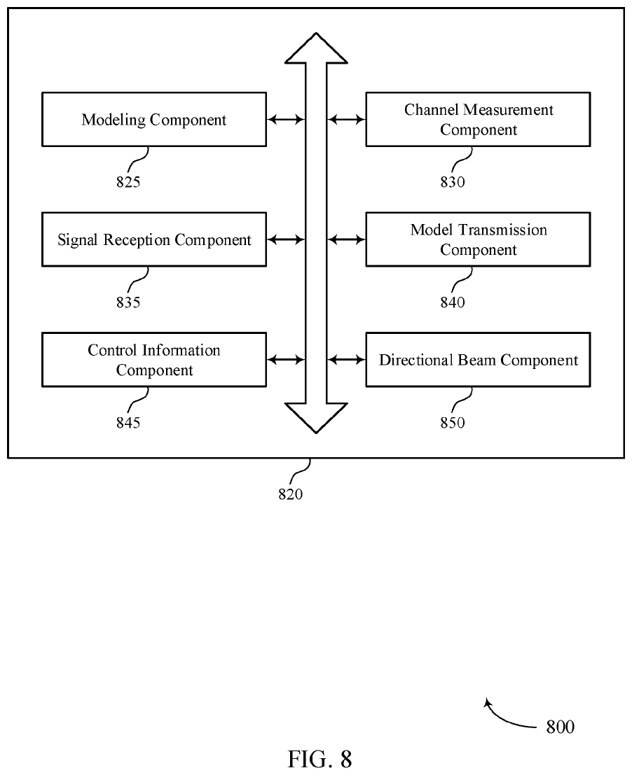

FIG. 8 shows a block diagram 800 of a communications manager 820 that supports techniques for beam characteristic prediction using federated learning processes in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for beam characteristic prediction using federated learning processes as described herein. For example, the communications manager 820 may include a modeling component 825, a channel measurement component 830, a signal reception component 835, a model transmission component 840, a control information component 845, a directional beam component 850, or any combination thereof. Each of these components may communicate, directly or indirectly, with one another (e.g., via one or more buses).

The communications manager 820 may support wireless communication at a first network node in accordance with examples as disclosed herein. The modeling component 825 may be configured as or otherwise support a means for receiving a first model configured to predict at least one of time-domain characteristics or spatial-domain characteristics associated with a set of channel measurement resources. The channel measurement component 830 may be configured as or otherwise support a means for generating first measurement information corresponding to a first quantity of channel measurement resources of the set of channel measurement resources, where the first quantity of channel measurement resources correspond to a first set of signals. In some examples, the modeling component 825 may be configured as or otherwise support a means for inputting the first measurement information into the first model. In some examples, the modeling component 825 may be configured as or otherwise support a means for obtaining, as an output of the first model, first predicted information corresponding to a second quantity of channel measurement resources of the set of channel measurement resources, where the first predicted information includes at least one of: one or more predicted time-domain parameters or one or more predicted spatial-domain parameters. The signal reception component 835 may be configured as or otherwise support a means for receiving a second set of signals, where the second quantity of channel measurement resources correspond to the second set of signals.

In some examples, the channel measurement component 830 may be configured as or otherwise support a means for generating second measurement information corresponding to the second quantity of channel measurement resources. In some examples, the modeling component 825 may be configured as or otherwise support a means for training the first model with the second measurement information, where training the first model with the second measurement information includes inputting the second measurement information into the first model. In some examples, the model transmission component 840 may be configured as or otherwise support a means for transmitting the trained first model to a second network node.

In some examples, the modeling component 825 may be configured as or otherwise support a means for receiving, from the second network node, a second model based on the trained first model and a third model associated with the set of channel measurement resources, where the second model is configured to predict least one of time-domain characteristics or spatial-domain characteristics of the set of channel measurement resources. In some examples, the modeling component 825 may be configured as or otherwise support a means for obtaining, as an output of the second model, second predicted information corresponding to the set of channel measurement resources, where the second predicted information includes at least one of: one or more time-domain parameters or one or more spatial-domain parameters.

In some examples, the modeling component 825 may be configured as or otherwise support a means for training the first model with a set of identifiers associated with the second quantity of channel measurement resources, where the set of identifiers corresponds to the second measurement information, and where training the first model with the set of identifiers includes inputting the set of identifiers into the first model.

In some examples, the control information component 845 may be configured as or otherwise support a means for receiving, from a second network node, control information indicating at least one of: the first quantity of channel measurement resources or the second quantity of channel measurement resources.

In some examples, the first quantity of channel measurement resources is based on the periodicity, or the second quantity of channel measurement resources is based on the periodicity.

In some examples, the first quantity of channel measurement resources is associated with a first set of time instances. In some examples, the second quantity of channel measurement resources is associated with a second set of time instances different from the first set of time instances. In some examples, the one or more predicted time-domain parameters include predicted measurements associated with the second quantity of channel measurement resources associated with the second set of time instances.

In some examples, the first quantity of channel measurement resources is associated with a first set of spatial filters at a second network node. In some examples, the second quantity of channel measurement resources is associated with a second set of spatial filters at the second network node. In some examples, the one or more predicted spatial-domain parameters include predicted measurements associated with the second quantity of channel measurement resources transmitted via the second set of spatial filters at the second network node.

In some examples, the directional beam component 850 may be configured as or otherwise support a means for receiving a first set of beams, where the first set of beams includes the first set of signals corresponding to the first quantity of channel measurement resources. In some examples, the modeling component 825 may be configured as or otherwise support a means for inputting a first set of beam identifiers corresponding to the first set of beams into the first model, where the first predicted information is based on the first set of beam identifiers.

In some examples, the modeling component 825 may be configured as or otherwise support a means for obtaining, as an additional output of the first model, second predicted information including a second set of beam identifiers corresponding to a second set of beams, the second set of beam identifiers associated with the second quantity of channel measurement resources.

In some examples, the first model is associated with one or more serving cells, one or more bandwidth parts, one or more channel measurement resource sets, a channel state information reporting configuration, or any combination thereof.

In some examples, the control information component 845 may be configured as or otherwise support a means for receiving, from a second network node, control information indicating the one or more serving cells, the one or more bandwidth parts, the one or more channel measurement resource sets, the channel state information reporting configuration, or any combination thereof.

In some examples, the first model includes a federated learning model, a distributed learning model, a machine learning model, or any combination thereof.

In some examples, receiving the first model includes receiving the first model from a second network node. In some examples, the first network node includes a UE. In some examples, the second network node includes a base station, a network entity, a server, or any combination thereof.

In some examples, the set of channel measurement resources comprises at least one of channel state information reference signal resources or synchronization signal block resources.

In some examples, a reference signal received power, a signal-to-noise ratio, a signal-to-interference-plus-noise ratio, a channel quality indicator, a rank indicator, a pre-coding matrix indicator, or any combination thereof.

In some examples, to support receiving the first model, the modeling component 825 may be configured as or otherwise support a means for receiving a download including the first model. In some examples, to support receiving the first model, the modeling component 825 may be configured as or otherwise support a means for receiving the first model via control signaling from a second network node, or both.

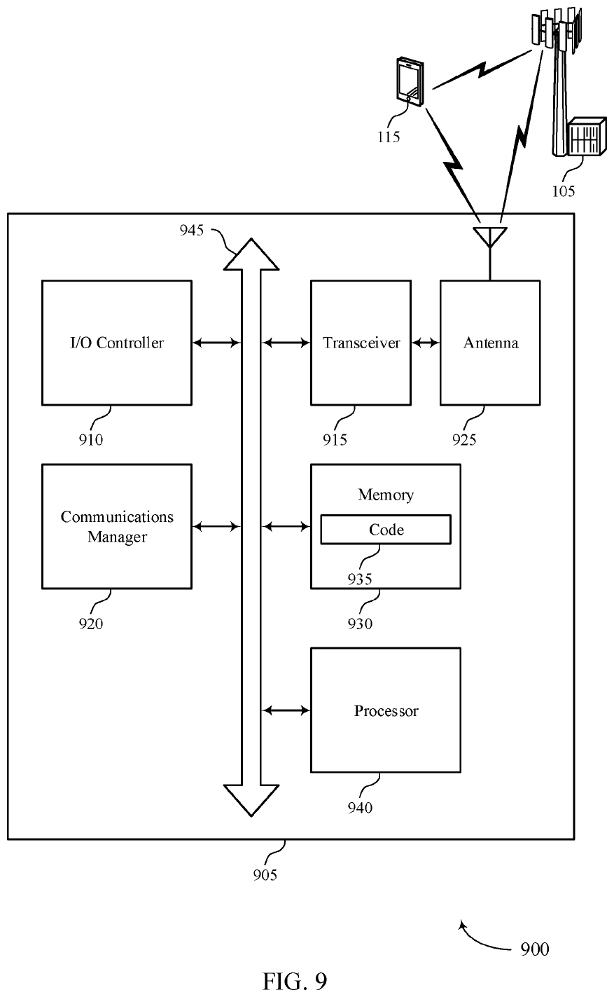

FIG. 9 shows a diagram of a system 900 including a device 905 that supports techniques for beam characteristic prediction using federated learning processes in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting techniques for beam characteristic prediction using federated learning processes). For example, the device 905 or a component of the device 905 may include a processor 940 and memory 930 coupled with or to the processor 940, the processor 940 and memory 930 configured to perform various functions described herein.

The communications manager 920 may support wireless communication at a first network node in accordance with examples as disclosed herein. For example, the communications manager 920 may be configured as or otherwise support a means for receiving a first model configured to predict at least one of time-domain characteristics or spatial-domain characteristics associated with a set of channel measurement resources. The communications manager 920 may be configured as or otherwise support a means for generating first measurement information corresponding to a first quantity of channel measurement resources of the set of channel measurement resources, where the first quantity of channel measurement resources correspond to a first set of signals. The communications manager 920 may be configured as or otherwise support a means for inputting the first measurement information into the first model. The communications manager 920 may be configured as or otherwise support a means for obtaining, as an output of the first model, first predicted information corresponding to a second quantity of channel measurement resources of the set of channel measurement resources, where the first predicted information includes at least one of: one or more predicted time-domain parameters or one or more predicted spatial-domain parameters. The communications manager 920 may be configured as or otherwise support a means for receiving a second set of signals, where the second quantity of channel measurement resources correspond to the second set of signals.

By including or configuring the communications manager 920 in accordance with examples as described herein, the device 905 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of techniques for beam characteristic prediction using federated learning processes as described herein, or the processor 940 and the memory 930 may be otherwise configured to perform or support such operations.

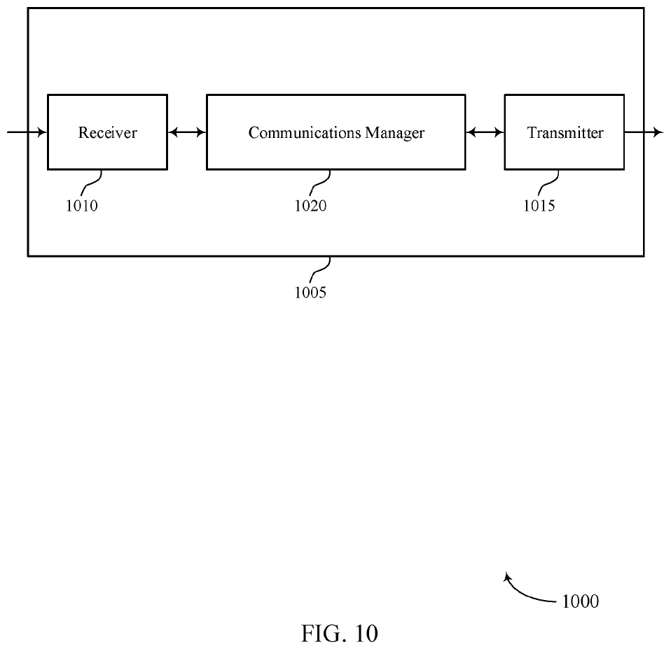

FIG. 10 shows a block diagram 1000 of a device 1005 that supports techniques for beam characteristic prediction using federated learning processes in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of techniques for beam characteristic prediction using federated learning processes as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a first network node in accordance with examples as disclosed herein. For example, the communications manager 1020 may be configured as or otherwise support a means for transmitting signals within a set of channel measurement resources. The communications manager 1020 may be configured as or otherwise support a means for receiving, from a second network node, a first trained model associated with at least a first portion of the set of channel measurement resources, the first trained model configured to predict at least one of time-domain characteristics or spatial-domain characteristics associated with the set of channel measurement resources. The communications manager 1020 may be configured as or otherwise support a means for receiving, from a third network node, a second trained model associated with at least a second portion of the set of channel measurement resources, the second trained model configured to predict at least one of time-domain characteristics or spatial-domain characteristics of the set of channel measurement resources. The communications manager 1020 may be configured as or otherwise support a means for generating a third model based on the first trained model and the second trained model, the third model configured to predict at least one of time-domain characteristics or spatial-domain characteristics associated with the set of channel measurement resources. The communications manager 1020 may be configured as or otherwise support a means for transmitting, to at least one of the second network node or the third network node, an indication of the third model.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for reduced processing, reduced power consumption, and more efficient utilization of communication resources.

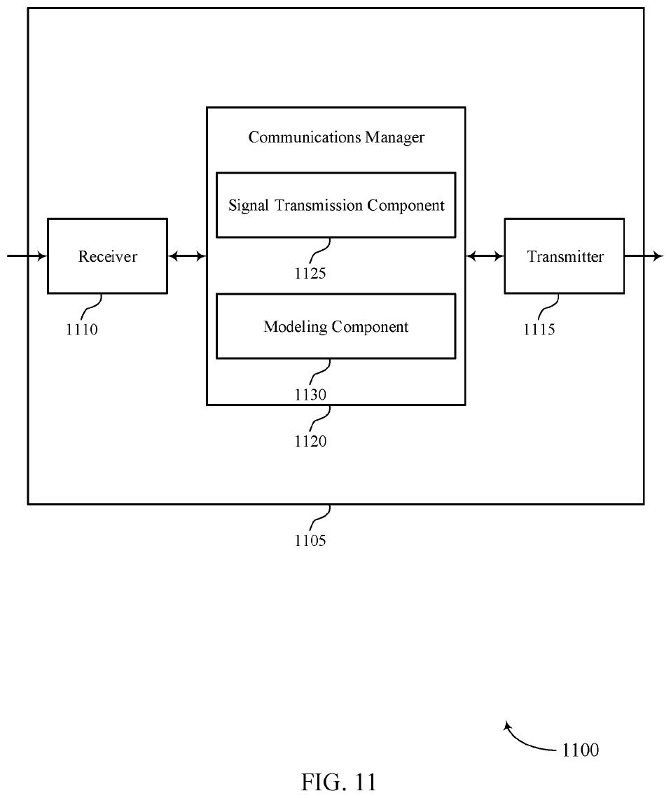

FIG. 11 shows a block diagram 1100 of a device 1105 that supports techniques for beam characteristic prediction using federated learning processes in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of techniques for beam characteristic prediction using federated learning processes as described herein. For example, the communications manager 1120 may include a signal transmission component 1125 a modeling component 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a first network node in accordance with examples as disclosed herein. The signal transmission component 1125 may be configured as or otherwise support a means for transmitting signals within a set of channel measurement resources. The modeling component 1130 may be configured as or otherwise support a means for receiving, from a second network node, a first trained model associated with at least a first portion of the set of channel measurement resources, the first trained model configured to predict at least one of time-domain characteristics or spatial-domain characteristics associated with the set of channel measurement resources. The modeling component 1130 may be configured as or otherwise support a means for receiving, from a third network node, a second trained model associated with at least a second portion of the set of channel measurement resources, the second trained model configured to predict at least one of time-domain characteristics or spatial-domain characteristics of the set of channel measurement resources. The modeling component 1130 may be configured as or otherwise support a means for generating a third model based on the first trained model and the second trained model, the third model configured to predict at least one of time-domain characteristics or spatial-domain characteristics associated with the set of channel measurement resources. The modeling component 1130 may be configured as or otherwise support a means for transmitting, to at least one of the second network node or the third network node, an indication of the third model.

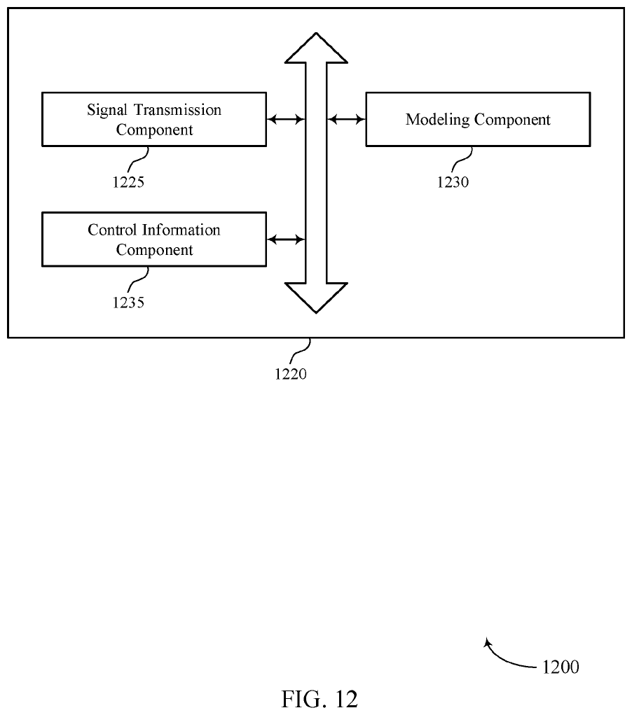

FIG. 12 shows a block diagram 1200 of a communications manager 1220 that supports techniques for beam characteristic prediction using federated learning processes in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of techniques for beam characteristic prediction using federated learning processes as described herein. For example, the communications manager 1220 may include a signal transmission component 1225, a modeling component 1230, a control information component 1235, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication at a first network node in accordance with examples as disclosed herein. The signal transmission component 1225 may be configured as or otherwise support a means for transmitting signals within a set of channel measurement resources. The modeling component 1230 may be configured as or otherwise support a means for receiving, from a second network node, a first trained model associated with at least a first portion of the set of channel measurement resources, the first trained model configured to predict at least one of time-domain characteristics or spatial-domain characteristics associated with the set of channel measurement resources. In some examples, the modeling component 1230 may be configured as or otherwise support a means for receiving, from a third network node, a second trained model associated with at least a second portion of the set of channel measurement resources, the second trained model configured to predict at least one of time-domain characteristics or spatial-domain characteristics of the set of channel measurement resources. In some examples, the modeling component 1230 may be configured as or otherwise support a means for generating a third model based on the first trained model and the second trained model, the third model configured to predict at least one of time-domain characteristics or spatial-domain characteristics associated with the set of channel measurement resources. In some examples, the modeling component 1230 may be configured as or otherwise support a means for transmitting, to at least one of the second network node or the third network node, an indication of the third model.

In some examples, the control information component 1235 may be configured as or otherwise support a means for transmitting, to the second network node, control information indicating at least one of: a first quantity of channel measurement resources of the set of channel measurement resources or a second quantity of channel measurement resources of the set of channel measurement resources, where the first trained model is trained based on a subset of the signals transmitted within the first quantity of channel measurement resources.

In some examples, a periodicity is associated with the set of channel measurement resources. In some examples, at least one of the first quantity of channel measurement resources or the second quantity of channel measurement resources are based on the periodicity.

In some examples, the third model is associated with one or more serving cells, one or more bandwidth parts, one or more channel measurement resource sets, a channel state information reporting configuration, or any combination thereof.

In some examples, the control information component 1235 may be configured as or otherwise support a means for transmitting, to at least one of the second network node or the third network node, control information indicating the one or more serving cells, the one or more bandwidth parts, the one or more channel measurement resource sets, the channel state information reporting configuration, or any combination thereof.

In some examples, the third model includes a federated learning model, a distributed learning model, a machine learning model, or any combination thereof.

In some examples, at least one of the second network node or the third network node, includes a respective UE. In some examples, the first network node includes a base station, a network entity, a server, or any combination thereof.

In some examples, the set of channel measurement resources includes at least one of channel state information reference signal resources or synchronization signal block resources.

In some examples, the first portion of the set of channel measurement resources is the same as the second portion of the set of channel measurement resources.

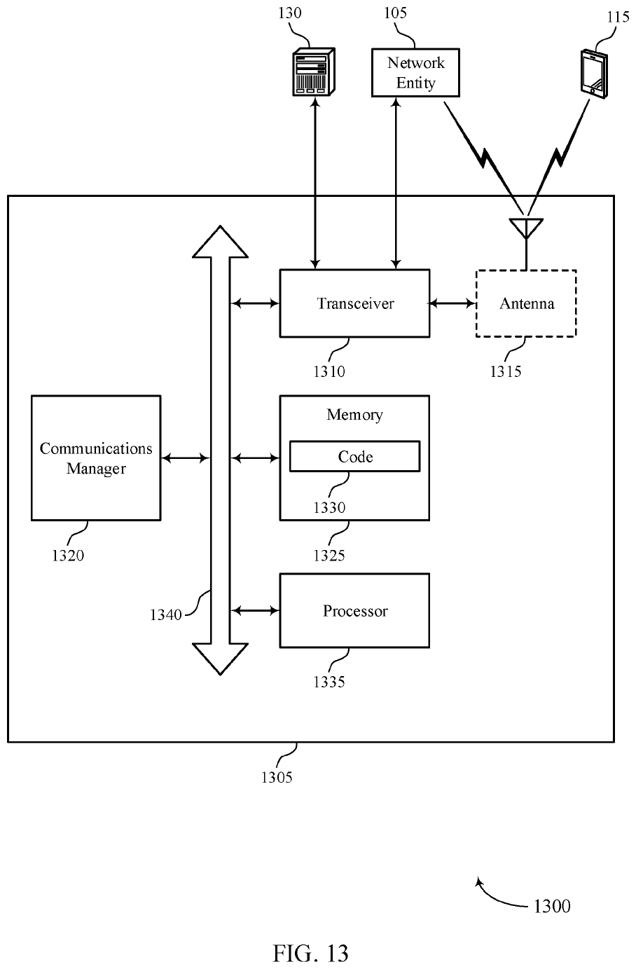

FIG. 13 shows a diagram of a system 1300 including a device 1305 that supports techniques for beam characteristic prediction using federated learning processes in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. The transceiver 1310, or the transceiver 1310 and one or more antennas 1315 or wired interfaces, where applicable, may be an example of a transmitter 1015, a transmitter 1115, a receiver 1010, a receiver 1110, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting techniques for beam characteristic prediction using federated learning processes). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communication at a first network node in accordance with examples as disclosed herein. For example, the communications manager 1320 may be configured as or otherwise support a means for transmitting signals within a set of channel measurement resources. The communications manager 1320 may be configured as or otherwise support a means for receiving, from a second network node, a first trained model associated with at least a first portion of the set of channel measurement resources, the first trained model configured to predict at least one of time-domain characteristics or spatial-domain characteristics associated with the set of channel measurement resources. The communications manager 1320 may be configured as or otherwise support a means for receiving, from a third network node, a second trained model associated with at least a second portion of the set of channel measurement resources, the second trained model configured to predict at least one of time-domain characteristics or spatial-domain characteristics of the set of channel measurement resources. The communications manager 1320 may be configured as or otherwise support a means for generating a third model based on the first trained model and the second trained model, the third model configured to predict at least one of time-domain characteristics or spatial-domain characteristics associated with the set of channel measurement resources. The communications manager 1320 may be configured as or otherwise support a means for transmitting, to at least one of the second network node or the third network node, an indication of the third model.

By including or configuring the communications manager 1320 in accordance with examples as described herein, the device 1305 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the processor 1335, the memory 1325, the code 1330, the transceiver 1310, or any combination thereof. For example, the code 1330 may include instructions executable by the processor 1335 to cause the device 1305 to perform various aspects of techniques for beam characteristic prediction using federated learning processes as described herein, or the processor 1335 and the memory 1325 may be otherwise configured to perform or support such operations.

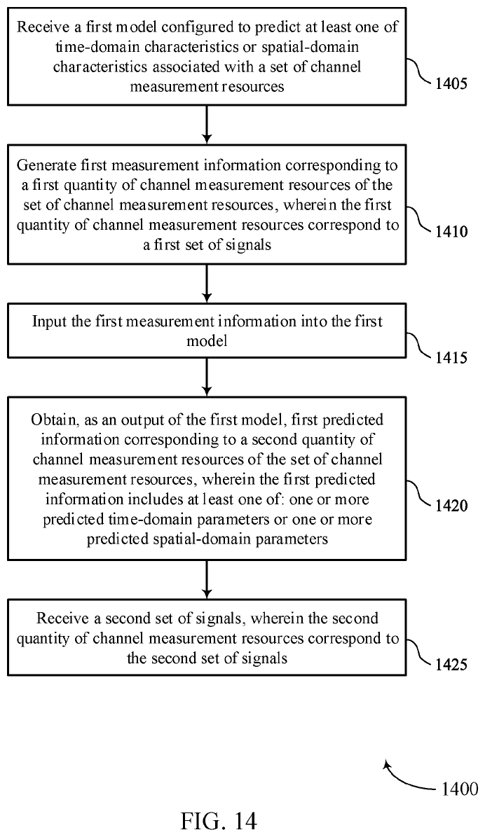

FIG. 14 shows a flowchart illustrating a method 1400 that supports techniques for beam characteristic prediction using federated learning processes in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving a first model configured to predict at least one of time-domain characteristics or spatial-domain characteristics associated with a set of channel measurement resources. The operations of 1405 may be performed in accordance with examples as disclosed herein. In some examples, aspects of the operations of 1405 may be performed by a modeling component 825 as described with reference to FIG. 8.

At 1410, the method may include generating first measurement information corresponding to a first quantity of channel measurement resources of the set of channel measurement resources, where the first quantity of channel measurement resources correspond to a first set of signals. The operations of 1410 may be performed in accordance with examples as disclosed herein. In some examples, aspects of the operations of 1410 may be performed by a channel measurement component 830 as described with reference to FIG. 8.

At 1415, the method may include inputting the first measurement information into the first model. The operations of 1415 may be performed in accordance with examples as disclosed herein. In some examples, aspects of the operations of 1415 may be performed by a modeling component 825 as described with reference to FIG. 8.

At 1420, the method may include obtaining, as an output of the first model, first predicted information corresponding to a second quantity of channel measurement resources of the set of channel measurement resources, where the first predicted information includes at least one of: one or more predicted time-domain parameters or one or more predicted spatial-domain parameters. The operations of 1420 may be performed in accordance with examples as disclosed herein. In some examples, aspects of the operations of 1420 may be performed by a modeling component 825 as described with reference to FIG. 8.

At 1425, the method may include receiving a second set of signals, where the second quantity of channel measurement resources correspond to the second set of signals. The operations of 1425 may be performed in accordance with examples as disclosed herein. In some examples, aspects of the operations of 1425 may be performed by a signal reception component 835 as described with reference to FIG. 8.

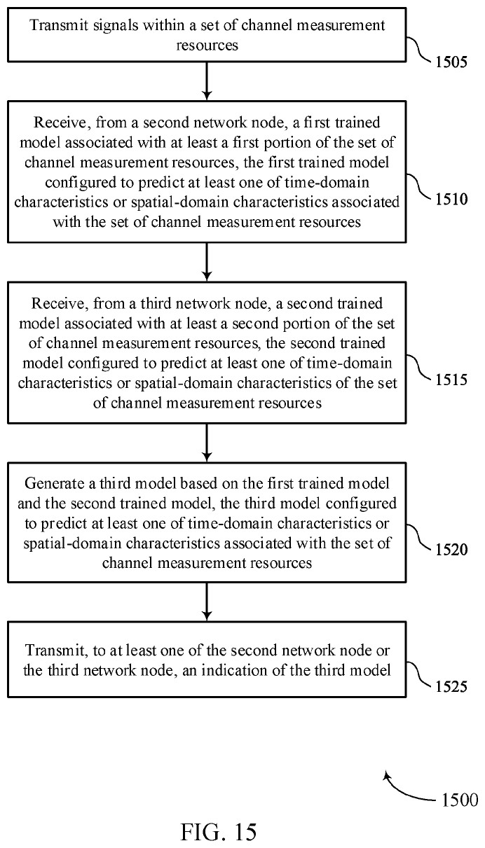

FIG. 15 shows a flowchart illustrating a method 1500 that supports techniques for beam characteristic prediction using federated learning processes in accordance with one or more aspects of the present disclosure. The operations of the method 1500 may be implemented by a network entity or its components as described herein. For example, the operations of the method 1500 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1505, the method may include transmitting signals within a set of channel measurement resources. The operations of 1505 may be performed in accordance with examples as disclosed herein. In some examples, aspects of the operations of 1505 may be performed by a signal transmission component 1225 as described with reference to FIG. 12.

At 1510, the method may include receiving, from a second network node, a first trained model associated with at least a first portion of the set of channel measurement resources, the first trained model configured to predict at least one of time-domain characteristics or spatial-domain characteristics associated with the set of channel measurement resources. The operations of 1510 may be performed in accordance with examples as disclosed herein. In some examples, aspects of the operations of 1510 may be performed by a modeling component 1230 as described with reference to FIG. 12.

At 1515, the method may include receiving, from a third network node, a second trained model associated with at least a second portion of the set of channel measurement resources, the second trained model configured to predict at least one of time-domain characteristics or spatial-domain characteristics of the set of channel measurement resources. The operations of 1515 may be performed in accordance with examples as disclosed herein. In some examples, aspects of the operations of 1515 may be performed by a modeling component 1230 as described with reference to FIG. 12.

At 1520, the method may include generating a third model based on the first trained model and the second trained model, the third model configured to predict at least one of time-domain characteristics or spatial-domain characteristics associated with the set of channel measurement resources. The operations of 1520 may be performed in accordance with examples as disclosed herein. In some examples, aspects of the operations of 1520 may be performed by a modeling component 1230 as described with reference to FIG. 12.

At 1525, the method may include transmitting, to at least one of the second network node or the third network node, an indication of the third model. The operations of 1525 may be performed in accordance with examples as disclosed herein. In some examples, aspects of the operations of 1525 may be performed by a modeling component 1230 as described with reference to FIG. 12.

The following provides an overview of aspects of the present disclosure:

Aspect 1: A method for wireless communication at a first network node, comprising: receiving a first model configured to predict at least one of time-domain characteristics or spatial-domain characteristics associated with a set of CMRs; generating first measurement information corresponding to a first quantity of CMRs of the set of CMRs, wherein the first quantity of CMRs correspond to a first set of signals; inputting the first measurement information into the first model; obtaining, as an output of the first model, first predicted information corresponding to a second quantity of CMRs of the set of CMRs, wherein the first predicted information includes at least one of: one or more predicted time-domain parameters or one or more predicted spatial-domain parameters; and receiving a second set of signals, wherein the second quantity of CMRs correspond to the second set of signals.

Aspect 2: The method of aspect 1, further comprising: generating second measurement information corresponding to the second quantity of CMRs; training the first model with the second measurement information, wherein training the first model with the second measurement information comprises inputting the second measurement information into the first model; and transmitting the trained first model to a second network node.

Aspect 3: The method of aspect 2, further comprising: receiving, from the second network node, a second model based on the trained first model and a third model associated with the set of CMRs, wherein the second model is configured to predict least one of time-domain characteristics or spatial-domain characteristics of the set of CMRs; and obtaining, as an output of the second model, second predicted information corresponding to the set of CMRs, wherein the second predicted information includes at least one of: one or more time-domain parameters or one or more spatial-domain parameters.

Aspect 4: The method of any of aspects 2 through 3, further comprising: training the first model with a set of identifiers associated with the second quantity of CMRs, wherein the set of identifiers corresponds to the second measurement information, and wherein training the first model with the set of identifiers comprises inputting the set of identifiers into the first model.

Aspect 5: The method of any of aspects 1 through 4, further comprising: receiving, from a second network node, control information indicating at least one of: the first quantity of CMRs or the second quantity of CMRs.

Aspect 6: The method of any of aspects 1 through 5, wherein a periodicity is associated with the set of CMRs, and wherein at least one of the first quantity of CMRs is based on the periodicity, or the second quantity of CMRs is based on the periodicity.

Aspect 7: The method of any of aspects 1 through 6, wherein the first quantity of CMRs is associated with a first set of time instances, and the second quantity of CMRs is associated with a second set of time instances different from the first set of time instances, and the one or more predicted time-domain parameters comprise predicted measurements associated with the second quantity of CMRs associated with the second set of time instances.

Aspect 8: The method of any of aspects 1 through 7, wherein the first quantity of CMRs is associated with a first set of spatial filters at a second network node, and the second quantity of CMRs is associated with a second set of spatial filters at the second network node, and the one or more predicted spatial-domain parameters comprise predicted measurements associated with the second quantity of CMRs transmitted via the second set of spatial filters at the second network node.

Aspect 9: The method of any of aspects 1 through 8, further comprising: receiving a first set of beams, wherein the first set of beams includes the first set of signals corresponding to the first quantity of CMRs; and inputting a first set of beam identifiers corresponding to the first set of beams into the first model, wherein the first predicted information is based on the first set of beam identifiers.

Aspect 10: The method of aspect 9, further comprising: obtaining, as an additional output of the first model, second predicted information comprising a second set of beam identifiers corresponding to a second set of beams, the second set of beam identifiers associated with the second quantity of CMRs.

Aspect 11: The method of any of aspects 1 through 10, wherein the first model is associated with one or more serving cells, one or more bandwidth parts, one or more CMR sets, a channel state information reporting configuration, or any combination thereof.

Aspect 12: The method of aspect 11, further comprising: receiving, from a second network node, control information indicating the one or more serving cells, the one or more bandwidth parts, the one or more CMR sets, the channel state information reporting configuration, or any combination thereof.

Aspect 13: The method of any of aspects 1 through 12, wherein the first model comprises a federated learning model, a distributed learning model, a machine learning model, or any combination thereof.

Aspect 14: The method of any of aspects 1 through 13, wherein receiving the first model comprises receiving the first model from a second network node, the first network node comprises a UE, and the second network node comprises a base station, a network entity, a server, or any combination thereof.

Aspect 15: The method of any of aspects 1 through 14, wherein the set of CMRs comprises at least one of: channel state information reference signal resources or synchronization signal block resources.

Aspect 16: The method of any of aspects 1 through 15, wherein at least one of the first measurement information, the one or more time-domain parameters of the first predicted information, and the one or more predicted spatial-domain parameters of the first predicted information comprise a reference signal received power, a signal-to-noise ratio, a signal-to-interference-plus-noise ratio, a channel quality indicator, a rank indicator, a pre-coding matrix indicator, or any combination thereof.

Aspect 17: The method of any of aspects 1 through 16, wherein the first model comprises a trained model, and wherein receiving the first model comprises: receiving a download including the first model; or receiving the first model via control signaling from a second network node, or both.

Aspect 18: A method for wireless communication at a first network node, comprising: transmitting signals within a set of CMRs; receiving, from a second network node, a first trained model associated with at least a first portion of the set of CMRs, the first trained model configured to predict at least one of time-domain characteristics or spatial-domain characteristics associated with the set of CMRs; receiving, from a third network node, a second trained model associated with at least a second portion of the set of CMRs, the second trained model configured to predict at least one of time-domain characteristics or spatial-domain characteristics of the set of CMRs; generating a third model based on the first trained model and the second trained model, the third model configured to predict at least one of time-domain characteristics or spatial-domain characteristics associated with the set of CMRs; and transmitting, to at least one of the second network node or the third network node, an indication of the third model.

Aspect 19: The method of aspect 18, further comprising: transmitting, to the second network node, control information indicating at least one of: a first quantity of CMRs of the set of CMRs or a second quantity of CMRs of the set of CMRs, wherein the first trained model is trained based at least in part on a subset of the signals transmitted within the first quantity of CMRs.

Aspect 20: The method of aspect 19, wherein a periodicity is associated with the set of CMRs, and at least one of the first quantity of CMRs or the second quantity of CMRs are based on the periodicity.

Aspect 21: The method of any of aspects 18 through 20, wherein the third model is associated with one or more serving cells, one or more bandwidth parts, one or more CMR sets, a channel state information reporting configuration, or any combination thereof.

Aspect 22: The method of aspect 21, further comprising: transmitting, to at least one of the second network node or the third network node, control information indicating the one or more serving cells, the one or more bandwidth parts, the one or more CMR sets, the channel state information reporting configuration, or any combination thereof.

Aspect 23: The method of any of aspects 18 through 22, wherein the third model comprises a federated learning model, a distributed learning model, a machine learning model, or any combination thereof.

Aspect 24: The method of any of aspects 18 through 23, wherein at least one of the second network node or the third network node, comprises a respective UE, and the first network node comprises a base station, a network entity, a server, or any combination thereof.

Aspect 25: The method of any of aspects 18 through 24, wherein the set of CMRs comprises at least one of channel state information reference signal resources or synchronization signal block resources.

Aspect 26: The method of any of aspects 18 through 25, wherein the first portion of the set of CMRs is the same as the second portion of the set of CMRs.

Aspect 27: A first network node for wireless communication, comprising a memory; and at least one processor coupled to the memory, the at least one processor configured to perform a method of any of aspects 1 through 17.

Aspect 28: An apparatus for wireless communication at a first network node, comprising a processor; memory coupled with the processor; and instructions stored in the memory and executable by the processor to cause the apparatus to perform a method of any of aspects 1 through 17.

Aspect 29: An apparatus for wireless communication at a first network node, comprising at least one means for performing a method of any of aspects 1 through 17.

Aspect 30: A non-transitory computer-readable medium storing code for wireless communication at a first network node, the code comprising instructions executable by a processor to perform a method of any of aspects 1 through 17.

Aspect 31: A first network node for wireless communication, comprising a memory; and at least one processor coupled to the memory, the at least one processor configured to perform a method of any of aspects 18 through 26.

Aspect 32: An apparatus for wireless communication at a first network node, comprising a processor; memory coupled with the processor; and instructions stored in the memory and executable by the processor to cause the apparatus to perform a method of any of aspects 18 through 26.

Aspect 33: An apparatus for wireless communication at a first network node, comprising at least one means for performing a method of any of aspects 18 through 26.

Aspect 34: A non-transitory computer-readable medium storing code for wireless communication at a first network node, the code comprising instructions executable by a processor to perform a method of any of aspects 18 through 26.

The methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the figures, describes example configurations and does not represent all the examples that may be implemented or that are within the scope of the claims. The term “aspect” or “example” used herein means “serving as an aspect, example, instance, or illustration,” and not “preferred” or “advantageous over other aspects.” The detailed description includes specific details for the purpose of providing an understanding of the described techniques. These techniques, however, may be practiced without these specific details. In some instances, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first network node for wireless communication, comprising:
a memory; and
at least one processor coupled to the memory, wherein the at least one processor is configured to:
receive a first model configured to predict at least one of time-domain characteristics or spatial-domain characteristics associated with a set of channel measurement resources;
generate first measurement information corresponding to a first quantity of channel measurement resources of the set of channel measurement resources, wherein the first quantity of channel measurement resources correspond to a first set of signals;
input the first measurement information into the first model;
obtain, as an output of the first model, first predicted information corresponding to a second quantity of channel measurement resources of the set of channel measurement resources, wherein the first predicted information includes at least one of: one or more predicted time-domain parameters or one or more predicted spatial-domain parameters; and
receive a second set of signals, wherein the second quantity of channel measurement resources correspond to the second set of signals.

2. The first network node of claim 1, wherein the at least one processor is further configured to:
generate second measurement information corresponding to the second quantity of channel measurement resources;
train the first model with the second measurement information, wherein to train the first model with the second measurement information, the at least one processor is configured to input the second measurement information into the first model; and
transmit the trained first model to a second network node.

3. The first network node of claim 2, wherein the at least one processor is further configured to:
receive, from the second network node, a second model based on the trained first model and a third model associated with the set of channel measurement resources, wherein the second model is configured to predict least one of time-domain characteristics or spatial-domain characteristics of the set of channel measurement resources; and
obtain, as an output of the second model, second predicted information corresponding to the set of channel measurement resources, wherein the second predicted information includes at least one of: one or more time-domain parameters or one or more spatial-domain parameters.

4. The first network node of claim 2, wherein the at least one processor is further configured to:
train the first model with a set of identifiers associated with the second quantity of channel measurement resources, wherein the set of identifiers corresponds to the second measurement information, and wherein to train the first model with the set of identifiers, the at least one processor is configured to input the set of identifiers into the first model.

5. The first network node of claim 1, wherein the at least one processor is further configured to:
receive, from a second network node, control information indicating at least one of: the first quantity of channel measurement resources or the second quantity of channel measurement resources.

6. The first network node of claim 1, wherein a periodicity is associated with the set of channel measurement resources, and wherein at least one of:
the first quantity of channel measurement resources is based on the periodicity, or the second quantity of channel measurement resources is based on the periodicity.

7. The first network node of claim 1, wherein:
the first quantity of channel measurement resources is associated with a first set of time instances, and wherein the second quantity of channel measurement resources is associated with a second set of time instances different from the first set of time instances; and
the one or more predicted time-domain parameters comprise predicted measurements associated with the second quantity of channel measurement resources associated with the second set of time instances.

8. The first network node of claim 1, wherein:
the first quantity of channel measurement resources is associated with a first set of spatial filters at a second network node, and wherein the second quantity of channel measurement resources is associated with a second set of spatial filters at the second network node, and
the one or more predicted spatial-domain parameters comprise predicted measurements associated with the second quantity of channel measurement resources transmitted via the second set of spatial filters at the second network node.

9. The first network node of claim 1, wherein the at least one processor is further configured to:
receive a first set of beams, wherein the first set of beams includes the first set of signals corresponding to the first quantity of channel measurement resources; and
input a first set of beam identifiers corresponding to the first set of beams into the first model, wherein the first predicted information is based on the first set of beam identifiers.

10. The first network node of claim 9, wherein the at least one processor is further configured to:
obtain, as an additional output of the first model, second predicted information comprising a second set of beam identifiers corresponding to a second set of beams, the second set of beam identifiers associated with the second quantity of channel measurement resources.

11. The first network node of claim 1, wherein the first model is associated with one or more serving cells, one or more bandwidth parts, one or more channel measurement resource sets, a channel state information reporting configuration, or any combination thereof.

12. The first network node of claim 11, wherein the at least one processor is further configured to:
receive, from a second network node, control information indicating the one or more serving cells, the one or more bandwidth parts, the one or more channel measurement resource sets, the channel state information reporting configuration, or any combination thereof.

13. The first network node of claim 1, wherein the first model comprises a federated learning model, a distributed learning model, a machine learning model, or any combination thereof.

14. The first network node of claim 1, wherein to receive the first model, the at least one processor is configured to receive the first model from a second network node, wherein the first network node comprises a user equipment (UE), and wherein the second network node comprises a base station, a network entity, a server, or any combination thereof.

15. The first network node of claim 1, wherein the set of channel measurement resources comprises at least one of: channel state information reference signal resources or synchronization signal block resources.

16. The first network node of claim 1, wherein at least one of the first measurement information, the one or more time-domain parameters of the first predicted information, and the one or more predicted spatial-domain parameters of the first predicted information comprise:
a reference signal received power, a signal-to-noise ratio, a signal-to-interference-plus-noise ratio, a channel quality indicator, a rank indicator, a pre-coding matrix indicator, or any combination thereof.

17. The first network node of claim 1, wherein the first model comprises a trained model, and wherein, to receive the first model, the at least one processor is configured to:
receive a download including the first model; or
receive the first model via control signaling from a second network node, or both.

18. A first network node for wireless communication, comprising:
a memory; and
at least one processor coupled to the memory, wherein the at least one processor is configured to:
transmit signals within a set of channel measurement resources;
receive, from a second network node, a first trained model associated with at least a first portion of the set of channel measurement resources, the first trained model configured to predict at least one of time-domain characteristics or spatial-domain characteristics associated with the set of channel measurement resources;
receive, from a third network node, a second trained model associated with at least a second portion of the set of channel measurement resources, the second trained model configured to predict at least one of time-domain characteristics or spatial-domain characteristics of the set of channel measurement resources;
generate a third model based on the first trained model and the second trained model, the third model configured to predict at least one of time-domain characteristics or spatial-domain characteristics associated with the set of channel measurement resources; and
transmit, to at least one of the second network node or the third network node, an indication of the third model.

19. The first network node of claim 18, wherein the at least one processor is further configured to:
transmit, to the second network node, control information indicating at least one of: a first quantity of channel measurement resources of the set of channel measurement resources or a second quantity of channel measurement resources of the set of channel measurement resources, wherein the first trained model is trained based on a subset of the signals transmitted within the first quantity of channel measurement resources.

20. The first network node of claim 19, wherein a periodicity is associated with the set of channel measurement resources, and wherein at least one of the first quantity of channel measurement resources or the second quantity of channel measurement resources are based on the periodicity.

21. The first network node of claim 18, wherein the third model is associated with one or more serving cells, one or more bandwidth parts, one or more channel measurement resource sets, a channel state information reporting configuration, or any combination thereof.

22. The first network node of claim 21, wherein the at least one processor is further configured to:
transmit, to at least one of the second network node or the third network node, control information indicating the one or more serving cells, the one or more bandwidth parts, the one or more channel measurement resource sets, the channel state information reporting configuration, or any combination thereof.

23. The first network node of claim 18, wherein the third model comprises a federated learning model, a distributed learning model, a machine learning model, or any combination thereof.

24. The first network node of claim 18, wherein at least one of the second network node or the third network node, comprises a respective user equipment (UE), and wherein the first network node comprises a base station, a network entity, a server, or any combination thereof.

25. The first network node of claim 18, wherein the set of channel measurement resources comprises at least one of: channel state information reference signal resources or synchronization signal block resources.

26. The first network node of claim 18, wherein the first portion of the set of channel measurement resources is the same as the second portion of the set of channel measurement resources.

27. A method for wireless communication at a first network node, comprising:
receiving a first model configured to predict at least one of time-domain characteristics or spatial-domain characteristics associated with a set of channel measurement resources;
generating first measurement information corresponding to a first quantity of channel measurement resources of the set of channel measurement resources, wherein the first quantity of channel measurement resources correspond to a first set of signals;
inputting the first measurement information into the first model;
obtaining, as an output of the first model, first predicted information corresponding to a second quantity of channel measurement resources of the set of channel measurement resources, wherein the first predicted information includes at least one of: one or more predicted time-domain parameters or one or more predicted spatial-domain parameters; and
receiving a second set of signals, wherein the second quantity of channel measurement resources correspond to the second set of signals.

28. The method of claim 27, further comprising:
generating second measurement information corresponding to the second quantity of channel measurement resources;
training the first model with the second measurement information, wherein training the first model with the second measurement information comprises inputting the second measurement information into the first model; and
transmitting the trained first model to a second network node.

29. A method for wireless communication at a first network node, comprising:
transmitting signals within a set of channel measurement resources;
receiving, from a second network node, a first trained model associated with at least a first portion of the set of channel measurement resources, the first trained model configured to predict at least one of time-domain characteristics or spatial-domain characteristics associated with the set of channel measurement resources;
receiving, from a third network node, a second trained model associated with at least a second portion of the set of channel measurement resources, the second trained model configured to predict at least one of time-domain characteristics or spatial-domain characteristics of the set of channel measurement resources;
generating a third model based on the first trained model and the second trained model, the third model configured to predict at least one of time-domain characteristics or spatial-domain characteristics associated with the set of channel measurement resources; and
transmitting, to at least one of the second network node or the third network node, an indication of the third model.

30. The method of claim 29, further comprising:
transmitting, to the second network node, control information indicating at least one of: a first quantity of channel measurement resources of the set of channel measurement resources or a second quantity of channel measurement resources of the set of channel measurement resources, wherein the first trained model is trained based on a subset of the signals transmitted within the first quantity of channel measurement resources.
